(19) United States
(12) Patent Application Publication
(10) Pub. No.: US 2026/0280780 A1
(43) Pub. Date: Sep. 17, 2026

(54) FREQUENCY INTERLEAVING ACROSS CARRIERS OF AN AGGREGATED BANDWIDTH

(71) Applicant: QUALCOMM Incorporated, San Diego, CA (US)

(72) Inventors: Javier RODRIGUEZ FERNANDEZ, San Diego, CA (US); Ayan SENGUPTA, San Diego, CA (US); Kianoush HOSSEINI, San Diego, CA (US); Alberto RICO ALVARINO, San Diego, CA (US)

(21) Appl. No.: 19/076,927

(22) Filed: Mar. 11, 2025

(51) Int. Cl. H04L 5/00; H04W 72/30

(52) U.S. Cl. CPC H04L 5/0017; H04W 72/30

(57) ABSTRACT

Systems and techniques are provided for wireless communication. For example, an apparatus for wireless communication at a device can obtain a plurality of tones scheduled for an aggregated bandwidth including a plurality of carriers. The plurality of tones can include a set of tones for each code block (CB) of a set of CBs, and can be arranged in a first sequence of blocks of tones, each block including at least one corresponding tone from the set of tones for each CB. Based on the first sequence and an interleaving configuration associated with the aggregated bandwidth, an interleaved tone sequence can be determined for the plurality of tones. The corresponding tones included in each block of tones are mapped to a respective carrier of the plurality of carriers, based on the interleaved tone sequence. Using the interleaved tone sequence, the plurality of tones can be output on the aggregated bandwidth.

### INTRODUCTION

Aspects of the present disclosure generally relate to wireless communication and to techniques and apparatuses for frequency interleaving.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, provided is an apparatus for wireless communication at a device, comprising: one or more memories; and one or more processors coupled to the one or more memories and configured to cause the device to: obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB; determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and output, using the interleaved tone sequence, the plurality of tones on the aggregated bandwidth.

In another example, a method for wireless communication is provided, the method including: obtaining a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB; determining, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and outputting, using the interleaved tone sequence, the plurality of tones on the aggregated bandwidth.

In another example, a non-transitory computer-readable storage medium comprising instructions stored thereon which, when executed by at least one processor, causes the at least one processor to: obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB; determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and output, using the interleaved tone sequence, the plurality of tones on the aggregated bandwidth.

In another example, an apparatus is provided for wireless communication. The apparatus includes: means for obtaining a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB; means for determining, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and means for outputting, using the interleaved tone sequence, the plurality of tones on the aggregated bandwidth.

In another illustrative example, provided is an apparatus for wireless communication at a device, comprising: one or more memories; and one or more processors coupled to the one or more memories and configured to cause the device to: receive information indicative of an interleaving configuration associated with an aggregated bandwidth, wherein the aggregated bandwidth includes a plurality of carriers; receive a transmission corresponding to an interleaved tone sequence of a plurality of tones, wherein the transmission is received using the aggregated bandwidth; and determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

In another example, a method for wireless communication is provided, the method including: receiving information indicative of an interleaving configuration associated with an aggregated bandwidth, wherein the aggregated bandwidth includes a plurality of carriers; receiving a transmission corresponding to an interleaved tone sequence of a plurality of tones, wherein the transmission is received using the aggregated bandwidth; and determining, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

In another example, a non-transitory computer-readable storage medium comprising instructions stored thereon which, when executed by at least one processor, causes the at least one processor to: receive information indicative of an interleaving configuration associated with an aggregated bandwidth, wherein the aggregated bandwidth includes a plurality of carriers; receive a transmission corresponding to an interleaved tone sequence of a plurality of tones, wherein the transmission is received using the aggregated bandwidth; and determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

In another example, an apparatus is provided for wireless communication. The apparatus includes: means for receiving information indicative of an interleaving configuration associated with an aggregated bandwidth, wherein the aggregated bandwidth includes a plurality of carriers; means for receiving a transmission corresponding to an interleaved tone sequence of a plurality of tones, wherein the transmission is received using the aggregated bandwidth; and means for determining, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design ofa base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating an example of carrier aggregation (CA) and flexible spectrum integration (FSI) corresponding to respective examples of an aggregated bandwidth in a wireless network, in accordance with some examples;

FIG. 7 is an example of a transmission scheme of a wireless communication network, where the transmission scheme includes frequency interleaving operations after modulation according to a modulation coding scheme (MCS) and resource element (RE) mapping of the modulation symbols, in accordance with some examples;

FIG. 8 is a diagram illustrating an example of frequency interleaving implemented using a first interleaver configured for sub-block interleaving (e.g., intra-component carrier (CC) interleaving) and a second interleaver configured for inter-CC interleaving, in accordance with some examples;

FIG. 9A illustrates an example of Multicast Channel (MCH) Scheduling Information (MSI) signaling indicative of an inter-CC interleaving enablement indication, in accordance with some examples;

FIG. 9B illustrates an example of MCI signaling indicative of an inter-CC interleaving configuration indicated using an index value corresponding to a particular configuration of one or more parameters for generating an interleaved tone sequence, in accordance with some examples;

FIG. 9C illustrates an example of MCI signaling indicative of a tuple of respective values corresponding to the particular configuration of one or more parameters for generating an interleaved tone sequence, in accordance with some examples;

FIG. 10 illustrates an example of a plurality of CCs having different respective numbers of REs per CC, in accordance with some examples;

FIG. 11A illustrates an example of a first and second code block (CB) comprising a respective set of tones indexed according to a shared plurality of CB tone indices, wherein the respective set of tones for each CB are divided into blocks of tones according to the tone indices, in accordance with some examples

FIG. 11B illustrates an example of inter-CC frequency interleaving of the plurality of tones corresponding to the first and second CBs, where the inter-CC frequency interleaving is based on mapping or allocating respective blocks of tones across respective CCs of a plurality of CCs corresponding to an aggregated bandwidth and each including a number of REs that is an integer multiple of the number of CBs, in accordance with some examples;

FIG. 12 illustrates an example of inter-CC frequency interleaving of a plurality of tones corresponding to first and second CBs across respective CCs of a plurality of CCs corresponding to an aggregated bandwidth and including a number of REs that is not an integer multiple of the number of CBs, in accordance with some examples;

FIG. 13 is a flow diagram illustrating an example of a process for wireless communication, in accordance with some examples;

FIG. 14 is a flow diagram illustrating another example of a process for wireless communication, in accordance with some examples; and

FIG. 15 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a network entity (e.g., a base station, a 3GPP gNB for 5G/NR, a 3GPP eNB for 4G/LTE, a Wi-Fi access point (AP), or other network entity, etc.). For example, an access link may support uplink signaling, downlink signaling, connection procedures, etc. An example of an access link is a Uu link or interface (also referred to as an NR-Uu) between a 3GPP gNB and a UE. While aspects may be described herein using terminology commonly associated with a 5G or New Radio (NR) radio access technology (RAT), aspects of the present disclosure can be applied to other RATs, such as a 3G RAT, a 4G RAT, and/or any RAT subsequent to 5G (e.g., 6G, 7G, 8G, etc.).

A wireless device may support carrier aggregation (CA). For example, carrier aggregation can be based on the wireless device performing simultaneous operations on multiple carriers. Carrier aggregation can be used to combine multiple frequency carriers to increase bandwidth, improve data rates, etc. Carrier aggregation can be implemented using multiple component carriers (CCs) that are aggregated for uplink and/or downlink operations between a network entity and a UE. For example, in 5G NR, carrier aggregation may be performed to aggregate up to 16 CCs, each with a bandwidth of up to 100 MHz in FR1 (e.g., sub-6 GHz frequency range), or up to 400 MHz in FR2 (e.g., mmWave). The aggregation of the multiple CCs according to a carrier aggregation configuration corresponds to using the resources within each CC as disjoint sets of resources, with separate physical layer (PHY) and media access control layer (MAC) operations performed for each CC. For example, the number of PHY and/or MAC operations associated with a CA implementation can scale linearly with the number of CCs that are being aggregated.

Channel bonding and/or flexible spectrum integration (FSI) can be implemented to integrate multiple CCs (e.g., within the same or different bands) to form a virtual carrier or virtual cell that may be configured as a single logical entity for PHY and/or MAC layer operations of the network. The single logical entity associated with channel bonding of multiple carriers can also be referred to as a virtual carrier, and can include resources from within the same band, and/or can include resources from within different bands. Channel bonding can be performed for resources (e.g., carriers) that are contiguous and/or non-contiguous in the frequency domain. Contiguous resources in the frequency domain do not include one or more resource elements (REs) or subcarriers between adjacent carriers. Non-contiguous resources in the frequency domain include one or more REs or subcarriers between adjacent carriers of the aggregated bandwidth.

As noted above, an aggregated bandwidth of multiple carriers configured using channel bonding can be used as a single logical entity from the perspective of scheduling operations and hybrid automatic repeat request (HARQ) transmissions within the network. For example, the virtual carrier can include a plurality of CCs, physical carriers, or portions thereof. In some examples, the carriers included in an aggregated bandwidth using channel bonding can be the same as the carriers included in an aggregated bandwidth using CA. The multiple carriers in the channel bonding configuration are included in a single scheduling and HARQ entity of the network, and, unlike in CA implementations, the number of PHY and/or MAC operations performed for the set of carriers in the channel bonded aggregated bandwidth does not necessarily increase as the number of CCs increases. An aggregated bandwidth including a particular number of CCs configured using channel bonding can be implemented with a smaller number of decoding attempts by a UE than would be performed by the UE if the same number of CCs were to be configured as an aggregated bandwidth for a carrier aggregation implementation.

Channel bonding and carrier aggregation are both techniques that can be used to map a transport block (TB) over multiple CCs that are included in an aggregated bandwidth. The aggregated bandwidth comprises multiple carriers (e.g., CCs), which can be contiguous or non-contiguous in the frequency domain. In the example of carrier aggregation (CA), multiple carriers or frequency channels are combined into an aggregated bandwidth while the individual carriers remain separately scheduled. For example, each carrier in a CA configuration is independently scheduled and modulated, and maintains a respective (e.g., per-carrier) PHY layer configuration indicative of PHY parameters such as cyclic prefix length, subcarrier spacing (SCS), timing, etc. Wireless communications performed using carrier aggregation are implemented using separate (e.g., per-carrier) RF chains and processing by the UE and/or network entity (e.g., base station, gNB, etc.).

Channel bonding can be used to provide an aggregated bandwidth of multiple CCs, which can be the same as the CCs in the example CA configuration. In a channel bonding configuration, the multiple CCs of the aggregated bandwidth are implemented or configured as a single logical entity (e.g., a single wideband channel over the aggregated bandwidth, with scheduling and PHY layer configuration implemented for the single logical wideband channel rather than for each CC). Both carrier aggregation and channel bonding can be used to perform wireless communications where a transport block (TB) is mapped over some, or all, of the respective carriers within the aggregated bandwidth. For example, the TB can include a plurality of code blocks, where each code block is a subset of the TB. Transmission and reception can be performed at the TB level, the CB level, and/or a level of the data information represented within a CB (e.g., bit-level, symbol-level, etc.).

Mapping a TB over multiple CCs of an aggregated bandwidth can be performed using one or more interleavers, multiplexers, etc. For example, an interleaver can be configured to use an interleaving configuration to map and allocate respective portions of a TB (e.g., one or more CBs, or portions thereof) to different CCs of the aggregated bandwidth. In some examples, an interleaving configuration may indicate an interleaving pattern, which corresponds to repeated logic applied by the interleaver to distribute data components of an input TB to different CCs of the aggregated bandwidth, with the mapping between different portions of the input to particular CCs of the aggregated bandwidth indicated based on the interleaving pattern and/or the interleaving configuration.

Channel bonding implementations can be associated with a corresponding hardware impact for a UE, network entity, and/or network device, etc., that will perform wireless communications using the channel bonding implementation(s). For example, additional RF and other hardware resources may be provided in UEs and other devices configured to support channel bonding, where the hardware impact is based on factors such as the number of CCs within the aggregated bandwidth for the channel bonding configuration, the size (e.g., bandwidth) of the CCs within the aggregated bandwidth for the channel bonding configuration, and/or the separation (e.g., in the frequency domain, for example in units of REs, sub-carriers, tones, etc.) between adjacent CCs within the aggregated bandwidth for the channel bonding configuration.

In some examples, channel bonding can be used to provide generalization of one or more diversity techniques for the wireless communication network. Diversity techniques may also be referred to as diversity schemes, and may be used to improve signal reliability, reduce fading, etc., to increase the robustness and/or reliability of signals transmitted and received in the wireless communications network. Diversity scheme techniques can be implemented to provide redundancy across different domains (e.g., time domain diversity, frequency domain diversity, spatial diversity, polarization diversity, code diversity, etc.). Diversity schemes can include transmit diversity schemes and/or receiver diversity schemes. Channel coding can provide generalization of diversity schemes to apply across multiple CCs (e.g., based on applying diversity schemes configured for use within a single carrier, to the aggregated bandwidth using channel bonding of multiple CCs into a virtual carrier). For example, HARQ-based time interleaving across CCs can be implemented for aggregated bandwidths using channel bonding. In another example, frequency interleaving across CCs can be implemented for an aggregated bandwidth using channel bonding. Various other diversity schemes, coding techniques, etc., may be used across CCs, based on applying the other diversity schemes or coding techniques to the single logical carrier (e.g., virtual carrier) comprised by the aggregated bandwidth using channel bonding for a plurality of CCs.

In some cases, frequency interleaving (FI) across CCs may be used to increase diversity for channels that are relatively flat over the CCs. For example, channels that are relatively flat over the CCs can correspond to channels with slowly varying channel conditions for different CCs over time, and/or can refer to channels with small magnitudes of channel condition variations for different CCs. An example of channels that can be relatively flat over CCs is broadcast channels, which can have the same size within a geographical area. In some examples, frequency interleaving across CCs can additionally be used to improve network coverage, with improved network coverage corresponding to increased reliability of reception.

In some examples, channel bonding and/or aggregation of frequency resources is implemented by network operators to improve the performance of broadcasting solutions, and/or to increase frequency diversity in relatively small and/or relatively dense coverage areas of a wireless network. In some cases, channel bonding and/or aggregation of frequency resources is implemented by broadcast operators having discontinuous segments of spectrum within their licensed spectrum allocations. In some examples, broadcast in a wireless network may not support the aggregation of carriers and/or channels to provide one or more services using an aggregated bandwidth comprising multiple carriers and/or channels. In another example, multicast in a wireless network may not support the aggregation of carriers and/or channels to provide one or more services using an aggregated bandwidth comprising multiple carriers and/or channels.

Channel bonding and/or aggregation of frequency resources may be beneficial for improving network performance and/or stability. For example, channel bonding and/or aggregation of frequency resources may be beneficial in scenarios where a network operator is licensed to use multiple, discontinuous segments of spectrum, as channel bonding and/or aggregation of frequency resources can be used to implement an aggregated bandwidth that can be used as if it were a continuous segment of spectrum. The aggregated bandwidth may additionally increase network capacity, and may decrease the complexity of network management that can be associated with managing and operating each segment of the multiple, discontinuous segments of spectrum individually (e.g., as may be performed when channel bonding and/or aggregation of frequency resources is not used or is not available). In some examples, a wireless network may support the use of channel bonding and/or aggregation of frequency resources for one or more supported transmission types, while not supporting the use of channel bonding and/or aggregation of frequency resources for one or more unsupported transmission types.

As noted above, broadcast transmissions may, in at least some examples, be an unsupported transmission type for implementing channel bonding and/or aggregation of frequency resources. In another example, multicast transmissions may also be an example of an unsupported transmission type for implementing channel bonding and/or aggregation of frequency resources. There is a need for systems and techniques that can be used to provide broadcast and/or multicast implementations that support channel bonding and/or aggregation of resources from multiple carriers that are non-contiguous in frequency. For example, there is a need for broadcast and/or multicast implementations that can use channel bonding for the virtual aggregation of different carriers to increase frequency diversity based on the separation in the frequency domain between adjacent non-contiguous carriers of an aggregated bandwidth using channel bonding. It may be desirable to implement channel bonding and/or aggregation of frequency resources for broadcast and/or multicast in a wireless network. For example, channel bonding and/or aggregation of frequency resources for broadcast and/or multicast can increase a number of devices that receive a broadcast or multicast transmission over the aggregated bandwidth. Channel bonding and/or aggregation of frequency resources for broadcast and/or multicast may increase the frequency diversity of broadcast and/or multicast transmissions using the aggregated bandwidth, based on the frequency diversity between the multiple, discontinuous segments of spectrum aggregated within the aggregated bandwidth. Increased frequency diversity may improve the resiliency against and/or may mitigate the undesirable effects of fading, interference, and/or environmental conditions, for broadcast and/or multicast transmissions using the aggregated bandwidth. For example, channel bonding and/or aggregation of frequency resources for broadcast and/or multicast can improve signal reliability for devices receiving the broadcast or multicast transmission over the aggregated bandwidth. The improved signal reliability may be based at least in part on the increased frequency diversity associated with the aggregated bandwidth, where the increased frequency diversity is used to mitigate (e.g., decrease) effects of frequency-selective fading.

Systems, apparatuses, processes (also referred to as methods), and computer-readable media (collectively referred to as “systems and techniques”) are described herein that can be used to provide PHY layer support for channel bonding configurations corresponding to virtual aggregations of non-contiguous carriers and/or frequency resources. For example, the systems and techniques can be used to provide channel bonding configurations that can be used for broadcast and/or multicast in a wireless network, based on implementing an inter-carrier (e.g., inter-CC) multiplexer to interleave consecutive tones of a code block across the resource elements (REs) of different carriers of an aggregated bandwidth associated with the channel bonding configuration. The inter-CC multiplexer can also be referred to as an inter-CC interleaver, and can be used to implement broadcast and/or multicast over the aggregated bandwidth using channel bonding. For example, the inter-CC interleaver can map tones of multiple CBs across respective REs of different CCs within the aggregated bandwidth. The inter-CC interleaver can be implemented with a single PHY layer, for example corresponding to the single PHY layer operations associated with a virtual carrier (e.g., aggregated bandwidth) using a channel bonding configuration.

In some cases, the inter-CC interleaver can be used to maintain frequency diversity associated with intra-carrier subblock frequency interleaving. For example, frequency diversity can be maintained and/or provided by using the inter-CC interleaver to determine mapping information to allocate consecutive tones of each CB to respective REs across different CCs of an aggregated bandwidth, where the consecutive tones in each CB of a set of CBs being mapped are allocated with the same inter-CC separation (e.g., an inter-CC gap or offset in frequency).

In some examples, the systems and techniques can use information indicative of an interleaving configuration to enable or disable the inter-CC frequency interleaving of CB tones across the respective REs of a plurality of CCs included in an aggregated bandwidth. For example, the interleaving configuration information can comprise an indication to enable or disable (e.g., not enable) the inter-CC frequency interleaving across the CCs of the aggregated bandwidth. In some cases, the indication may be included in semi-static configuration information associated with Multimedia Broadcast Multicast Service (MBMS) services associated with a Multicast Broadcast Single Frequency Network (MBSFN) Area. For example, the inter-CC frequency interleaving indication can be included in a multicast control channel (MCCH) message. In some cases, the inter-CC frequency interleaving indication can be included in an MBSFN Area information element (IE) of the MCCH message. In some cases, the indication can be signaled using a Multicast Channel (MCH) Scheduling Information (MSI) Media Access Control (MAC) Control Element (MAC-CE).

The systems and techniques can be used to indicate one or more parameters of an interleaving configuration for inter-CC frequency interleaving. For example, the one or more parameters of the interleaving configuration can include an interleaving size and an interleaving depth. In some cases, parameter values of the interleaving configuration for inter-CC frequency interleaving can be included in an MSI. In some cases, the MSI can include an index value that is mapped to a tuple of values in a lookup table or data structure including a plurality of tuples of values each mapped to a respective index. Each tuple of values can be a different combination of the parameter values for the interleaving configuration for the inter-CC frequency interleaving. The one or more indicated parameters of the interleaving configuration can be used to implement inter-CC frequency interleaving (e.g., at a first device configured to generate and send an interleaved signal) and/or to implement inter-CC frequency deinterleaving (e.g., at a second device configured to receive the interleaved signal from the first device and perform deinterleaving of the received interleaved signal). Based on the indicated parameters of the interleaving configuration, the inter-CC frequency interleaving can be performed to provide channel bonding and/or aggregation of frequency resources for broadcast and/or multicast in a wireless network. For example, the interleaving configuration for inter-CC frequency interleaving and/or deinterleaving can be used to provide an aggregated bandwidth (e.g., over multiple, discontinuous segments of spectrum frequencies) that can be used for broadcast and/or multicast from an interleaving device to a plurality of receiving (e.g., deinterleaving) devices. Based on performing the inter-CC frequency interleaving according to the indicated one or more parameters of the interleaving configuration, the systems and techniques can be used to provide channel bonding and/or aggregation of frequency resources for broadcast and/or multicast in a wireless network.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A network entity (e.g., base station (e.g., with an aggregated/monolithic base station architecture or disaggregated base station architecture)) may operate according to one of several RATs in communication with UEs depending on the network in which it is deployed, and may be alternatively referred to as a network entity, an access point (AP), a network node, a NodeB (NB), an evolved NodeB (eNB), a next generation eNB (ng-eNB), a New Radio (NR) Node B (also referred to as a gNB or gNodeB), etc. A network entity (e.g., base station) may be used primarily to support wireless access by UEs, including supporting data, voice, and/or signaling connections for the supported UEs. In some systems, a network entity (e.g., base station) may provide edge node signaling functions while in other systems it may provide additional control and/or network management functions. A communication link through which UEs can send signals to a network entity (e.g., base station) is called an uplink (UL) channel (e.g., a reverse traffic channel, a reverse control channel, an access channel, etc.). A communication link through which the network entity (e.g., base station) can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

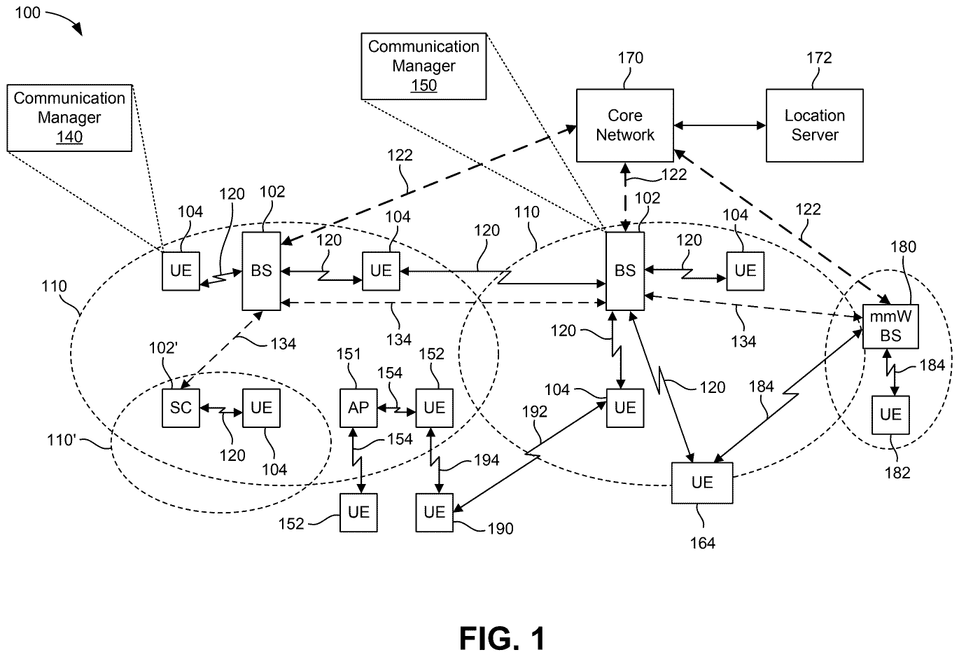

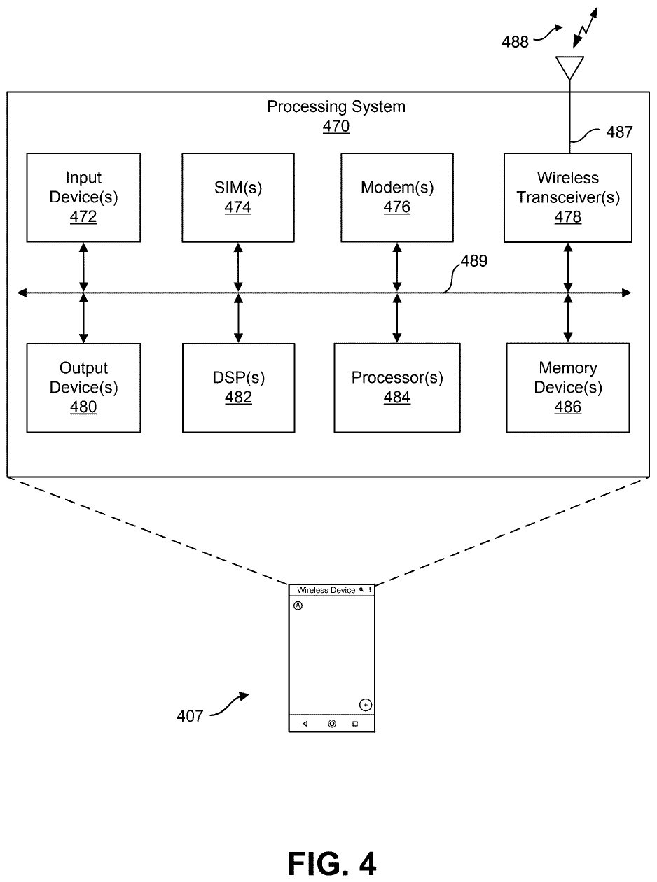

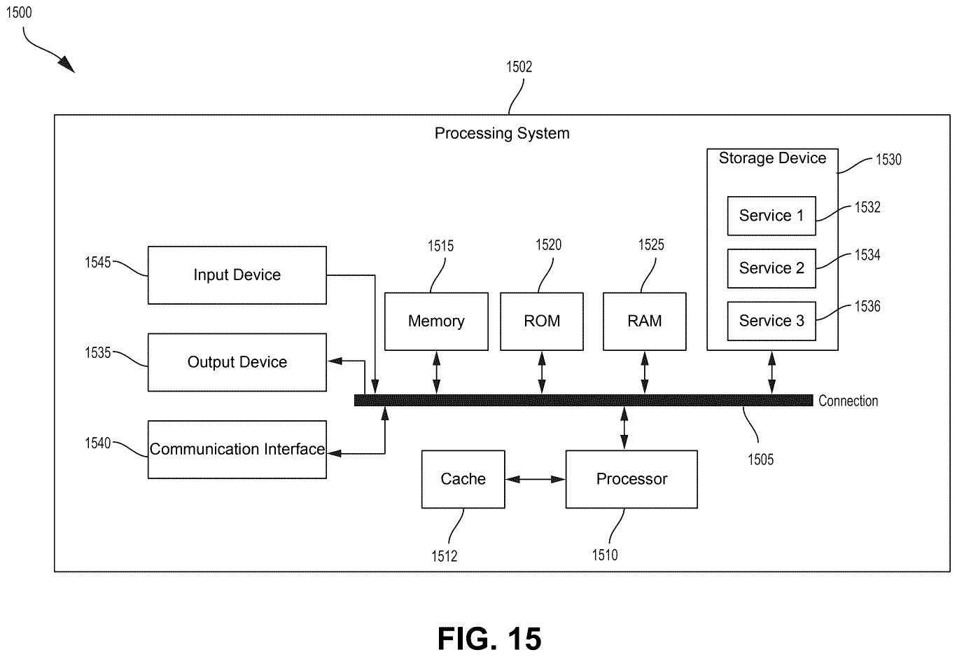

In some examples, the network entity 102 may include a processing system (e.g., such as the processing system 470 of FIG. 4 and/or the processing system 1502 of FIG. 15, etc.). Similarly, the millimeter wave (mmW) base station 180 of FIG. 1 may include a respective processing system (e.g., such as the processing system 470 of FIG. 4 and/or the processing system 1502 of FIG. 15, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 151 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 151 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 151, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 151. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 151 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

In some aspects, a UE (e.g., ULE 104) may include a communication manager 140. As described in more detail elsewhere herein, the communication manager 140 may obtain a plurality of tones scheduled for an aggregated bandwidth including a plurality of carriers. The plurality of tones can include a respective set of tones corresponding to each code block (CB) of a set of CBs. The plurality of tones can be arranged in a first sequence of blocks of tones, each block of tones of the first sequence of the blocks of tones including a corresponding tone from the respective set of tones corresponding to each CB. The communication manager 140 may determine, based on the first sequence of the blocks of tones and an interleaving configuration associated with the aggregated bandwidth, an interleaved tone sequence for the plurality of tones. The corresponding tones included in each block of tones of the first sequence of the blocks of tones can be mapped to a respective carrier of the plurality of carriers based at least in part on the interleaved tone sequence. The communication manager 140 may output, using the interleaved tone sequence, the plurality of tones on the aggregated bandwidth. Additionally, or alternatively, the communication manager 140 may perform one or more other operations described herein.

In some aspects, a UE (e.g., UE 104) may include the communication manager 140. As described in more detail elsewhere herein, the communication manager 140 may receive information indicative of an interleaving configuration associated with an aggregated bandwidth, wherein the aggregated bandwidth includes a plurality of carriers. The communication manager 140 may receive a transmission corresponding to an interleaved tone sequence of a plurality of tones, wherein the transmission is received using the aggregated bandwidth. The communication manager 140 may determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission. Additionally, or alternatively, the communication manager 140 may perform one or more other operations described herein.

In some aspects, a network entity (e.g., base station 102, a network node, etc.) may include a communication manager 150. As described in more detail elsewhere herein, the communication manager 150 may obtain a plurality of tones scheduled for an aggregated bandwidth including a plurality of carriers. The plurality of tones can include a respective set of tones corresponding to each code block (CB) of a set of CBs. The plurality of tones can be arranged in a first sequence of blocks of tones, each block of tones of the first sequence of the blocks of tones including a corresponding tone from the respective set of tones corresponding to each CB. The communication manager 150 may determine, based on the first sequence of the blocks of tones and an interleaving configuration associated with the aggregated bandwidth, an interleaved tone sequence for the plurality of tones. The corresponding tones included in each block of tones of the first sequence of the blocks of tones can be mapped to a respective carrier of the plurality of carriers based at least in part on the interleaved tone sequence. The communication manager 150 may output, using the interleaved tone sequence, the plurality of tones on the aggregated bandwidth. Additionally, or alternatively, the communication manager 150 may perform one or more other operations described herein.

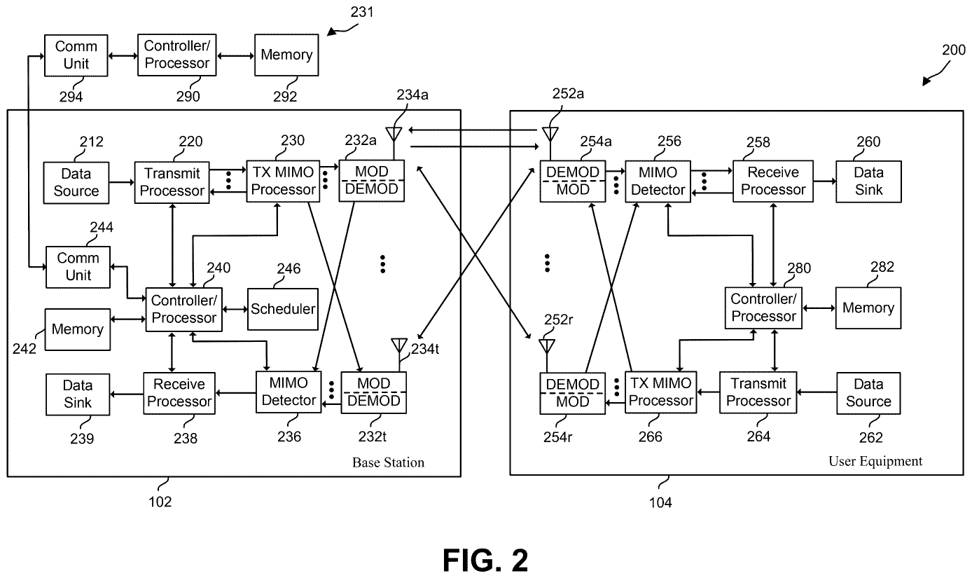

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

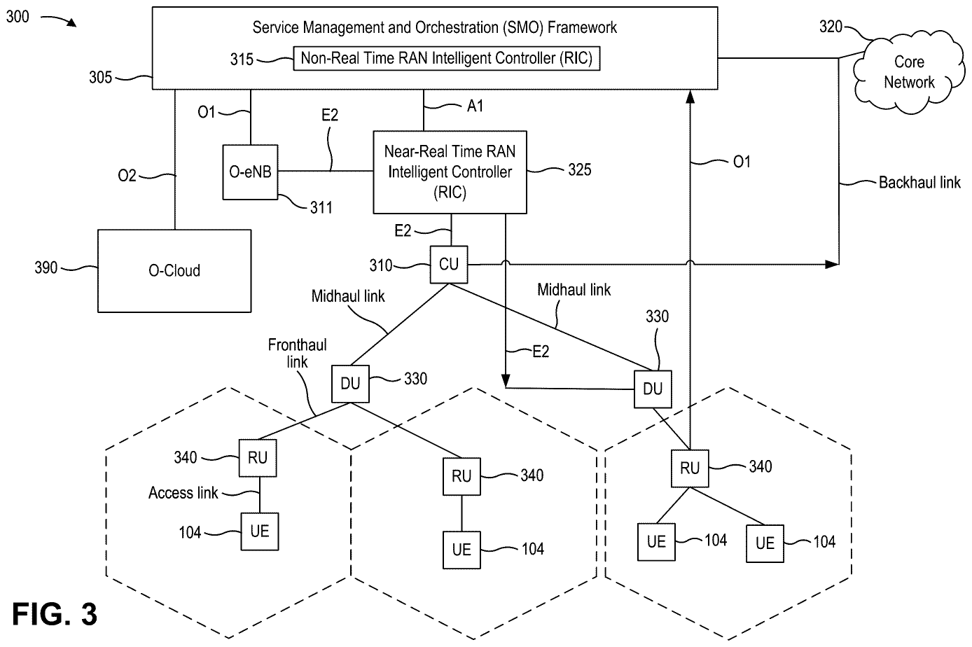

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 1502 of FIG. 15 (e.g., and the processing system 1502 of FIG. 15 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

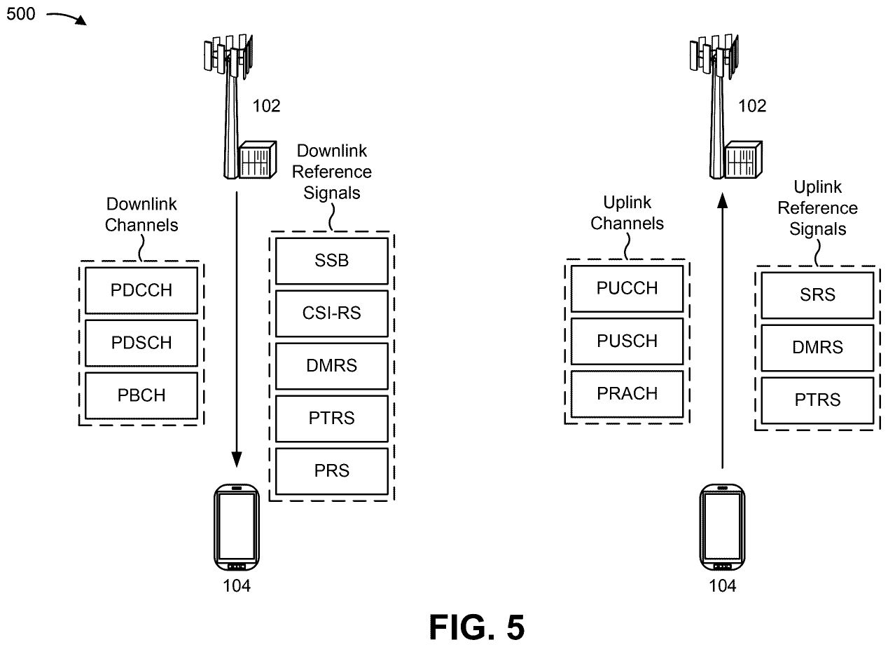

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

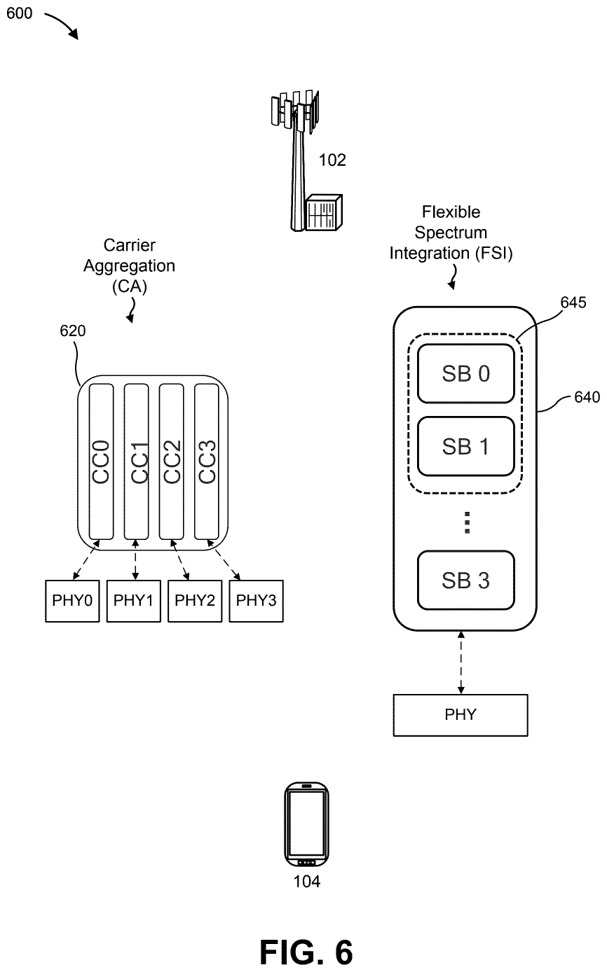

FIG. 6 is a diagram illustrating example aggregated bandwidths 600 that can be used for inter-carrier interleaving for PHY/MAC channel bonding for broadcast and/or flexible spectrum integration (FSI), in accordance with some examples. For example, a first aggregated bandwidth 620 can be an aggregated bandwidth corresponding to an implementation of carrier aggregation (CA) (e.g., also referred to as a CA bandwidth or aggregated CA bandwidth). A second aggregated bandwidth 640 can be an aggregated bandwidth corresponding to an implementation of flexible spectrum integration (FSI) and/or channel bonding (e.g., PHY/MAC channel bonding, etc.). The FSI aggregated bandwidth 640 may also be referred to as an aggregated bandwidth for a virtual cell and/or virtual carrier, etc. The virtual cell can be associated with flexible spectrum integration (FSI) in a wireless network including the network entity (e.g., base station, gNB, etc.) 102 and the UE 104. For example, communications between the base station 102 and the UE 104 can be performed using the virtual cell. The aggregated CA bandwidth 620 can be associated with carrier aggregation in the same wireless network that includes the base station 102 and the UE 104. For example, communications between the base station 102 and the UE 104 can be performed using the aggregated CA bandwidth 620. In some aspects, carrier aggregation can be a type of FSI and/or an FSI technique.

As noted above, the example aggregated CA bandwidth 620 can use carrier aggregation implemented using multiple component carriers (CCs) that are aggregated for uplink and/or downlink operations between a network entity (e.g., base station 102) and a UE (e.g., UE 104). For example, in 5G NR, carrier aggregation may be performed to aggregate up to 16 CCs, each with a bandwidth of up to 100 MHz in FR1 (e.g., sub-6 GHz frequency range), or up to 400 MHz in FR2 (e.g., mmWave). The aggregation of the multiple CCs can be implemented under a single scheduler. In one illustrative example, the aggregated CA bandwidth 620 can include a plurality of aggregated component carriers (CCs). For example, the aggregated CA bandwidth 620 includes the four CCs CC0, CC1, CC2, and CC3. The aggregated component carriers CC0-CC3 can be adjacent (e.g., contiguous in the frequency domain) carriers from within the same frequency band, corresponding to an intra-band contiguous CA configuration for the aggregated CA bandwidth 620. In another example, the aggregated component carriers CC0-CC3 can be non-adjacent (e.g., non-contiguous) carriers from within the same frequency band, corresponding to an intra-band non-contiguous CA configuration. In another example, the aggregated component carriers CC0-CC3 can be adjacent or non-adjacent carriers that are in different frequency bands, corresponding to an inter-band CA configuration.

In some examples, a plurality of CCs can be used or configured as respective sub-bands (SBs) for a virtual cell or virtual carrier, for example corresponding to an FSI configuration, a PHY/MAC channel bonding configuration, etc. For example, the virtual cell associated with the aggregated bandwidth 640 includes the plurality of SBs SB0, SB1, . . . , SB3, etc. In some aspects, the plurality of SBs aggregated within the virtual cell may be component carriers. In some examples, the plurality of SBs within the virtual cell can be the same as or similar to one or more of the component carriers CC)-CC3 within the aggregated CA bandwidth 620.

Various carrier aggregation techniques can correspond to using the resources within each CC as disjoint sets of resources, with separate physical layer (PHY) and media access control layer (MAC) operations performed for each CC. For example, the number of PHY and/or MAC operations associated with a CA implementation can scale linearly with the number of CCs that are being aggregated. For example, the first carrier (e.g., CC0) of the aggregated CA bandwidth 620 can correspond to first PHY layer operations PHY0; the second carrier (e.g., CC1) of the aggregated CA bandwidth 620 can correspond to a second set of PHY layer operations PHY1; the third carrier (e.g., CC2) of the aggregated CA bandwidth 620 can correspond to a third set of PHY layer operations PHY2; and the fourth carrier (e.g., CC3) of the aggregated CA bandwidth 620 can correspond to a fourth set of PHY layer operations PHY3; etc.

As used herein, a sub-band (SB) can refer to a sub-band that is included within a virtual cell or virtual carrier, where the virtual cell/carrier SB is one physical carrier or a portion of a physical carrier. As used herein, an SB can also refer to a physical carrier (or portion thereof) that is configured as a component carrier for carrier aggregation (e.g., an SB can be a CA CC, and a CA CC can be an SB, etc.). As used herein, an interleaver may, in some aspects, refer to an interleaving engine and/or an interleaving function, including various functions configured to receive an input comprising a plurality of discrete units (e.g., bits or groups of bits, in the time domain; tones, sub-carriers, modulated symbols, etc., within the frequency domain) arranged in a first sequence (e.g., a first order of the plurality of discrete units), and configured to generate an output comprising the same plurality of discrete units arranged in a second sequence (e.g., a second order) that is different from the first sequence.

The aggregated bandwidth 640 can be implemented using FSI and/or using channel bonding to aggregate a plurality of carriers (e.g., component carriers, sub-bands, etc.) corresponding to different respective frequency resources (e.g., non-overlapping and/or non-contiguous frequency resources per carrier of the aggregated bandwidth using FSI or channel bonding). The respective frequency resources of the bonded CCS of the aggregated bandwidth may be non-contiguous in the frequency domain. For example, channel bonding or aggregation of non-contiguous CCs and frequency resources can increase the frequency diversity provided across the virtual channel or virtual carrier that is implemented using the aggregated bandwidth. In some examples, FSI and/or channel bonding can be used to implement aggregated bandwidths, virtual carriers, virtual cells, etc., comprising discontinuous (e.g., non-continuous) CCs and frequency resources for network operators having discontinuous frequency spectrum allocations or licenses. Channel bonding or FSI can be performed to aggregate the plurality of non-continuous CCs into a single logical channel and/or a single logical (e.g., virtual) cell that comprises the aggregated bandwidth provided by the plurality of non-continuous CCs. For example, the virtual carrier or virtual cell can be a single logical entity that is implemented to appear as a single channel or single cell within the PHY layer (e.g., virtual channel or virtual cell for the PHY layer). In the example of FIG. 6, the aggregated bandwidth 640 includes the plurality of CCs or sub-bands SB0, SB1, . . . , SB3, which are aggregated into a single logical channel, carrier, cell, etc., for implementation in the PHY layer as a single entity, corresponding to the single PHY layer shown in FIG. 6 as being associated to the aggregated bandwidth 640.

In some cases, flexible spectrum integration (FSI) can be implemented to integrate multiple SBs and/or CCs to form a virtual carrier or virtual cell. For example, the virtual cell associated with the aggregated bandwidth 640 can be an integration of CCs (e.g., SBs) in the same or different bands, to form the single virtual carrier/cell. The virtual cell can be implemented as a single cell for scheduling and/or HARQ operations performed by the wireless network. For example, the UE 104 and the base station 102 can perform communications using the virtual cell as a single cell (e.g., the virtual cell is used as a single scheduling and HARQ entity). As used herein, the terms “virtual carrier” and “virtual cell” may be used interchangeably.

The virtual cell associated with the aggregated bandwidth 640 can include resources (e.g., respective resources included within and/or associated with each respective SB of the plurality of SBs SB0, SB1, . . . , SB3, etc.) from within the same band, and/or can include resources from within different bands. The virtual cell can include resources (e.g., SBs) that are contiguous and/or non-contiguous. For example, a plurality of different CCs can be configured as respective sub-bands (SBs) within the virtual carrier or virtual cell. The virtual cell associated with the aggregated bandwidth 640 can be used as a single cell from the perspective of scheduling operations and hybrid automatic repeat request (HARQ) transmissions. For example, the virtual cell can include the plurality of SBs SB0, SB1, . . . , SB3, etc., where each SB is one physical carrier or a portion thereof (e.g., a portion of one physical carrier). In some examples, the SBs (e.g., SB0-SB3) included within the virtual cell can be the same as the CCs (e.g., CC0-CC3) included within the aggregated CA bandwidth 620 (e.g., a CC used for carrier aggregation can be an SB used for FSI and/or included within a virtual carrier or virtual cell, and vice versa). The multiple SBs within the virtual cell associated with the aggregated bandwidth 640 are configured as a single scheduling and HARQ entity to the network (e.g., network entity or base station 102), and, unlike in CA implementations, the number of PHY and/or MAC operations performed for the aggregated bandwidth of the virtual cell does not necessarily increase as the number of CCs or SBs aggregated within the virtual cell increases.

In some aspects, SB0 and SB1 of the virtual cell associated with the aggregated bandwidth 640 can comprise a non-contiguous active bandwidth part (BWP) 645. For example, SB0 and SB1 can be included within the non-contiguous active BWP 645, which is configured for the single scheduling and HARQ entity comprising the virtual cell 640. In some cases, the virtual cell can receive one CC of PDCCH transmission(s) for scheduling. In some cases, the UE 104 can perform communications with the base station 102 with a smaller number of decoding attempts, based on the UE 104 performing the communications with the base station 102 using the single entity of the virtual cell associated with the aggregated bandwidth 640. The virtual cell can be associated with a narrow RF range for PDCCH transmissions, with the UE 104 configured to only open its RF when there is data. In some cases, the virtual cell utilizes one CORESET for the plurality of SBs SB0-SB3 included within the aggregated bandwidth of the virtual cell. The aggregated CA bandwidth 620 may include a respective CORESET for each CC (e.g., four CORESETs for the four CCs CC0-CC3 included within the aggregated CA bandwidth 620). For example, CA performed for a plurality of SBs (e.g., CCs) may correspond to the UE 104 detecting or performing blind decoding for a control resource set (CORESET) within each respective SB of the plurality of SBs. FSI and/or a virtual cell configured for the same plurality of SBs can correspond to the UE detecting a single CORESET for the virtual cell (e.g., a single CORESET shared across each SB of the plurality of SBs).

In some cases, the virtual cell associated with the aggregated bandwidth 640 can be used for unifying re-transmissions (e.g., between base station 102 and UE 104) across SBs (e.g., across the plurality of SBs SB0-SB3, and/or various combinations and sub-combinations thereof) for improved diversity on the re-transmission attempt(s). Various types and configurations of transport block (TB) scheduling may be used across aggregated SBs of a virtual cell. For example, small and scattered frequency division duplexing (FDD) channels can be integrated as one large virtual carrier with single-TB scheduling, where the FDD channels each comprise one or more SBs of the virtual cell. In some examples, multi-TB scheduling can be performed with a single-CC PDCCH for a relatively larger (e.g., larger) aggregated bandwidth. In some aspects, a bandwidth part (BWP)-based bandwidth adaptation can be used for low-latency adaptation based on an RF bandwidth associated with the UE 104 and/or based on one or more configured measurements of wireless conditions, etc. In single-TB scheduling and mapping, each TB is mapped onto a non-contiguous BWP activated within a virtual cell. The non-contiguous BWP that is activated within the virtual cell for the single-TB scheduling and mapping may include one or multiple SBs. For example, single-TB scheduling can be performed for the virtual cell associated with the aggregated bandwidth 640 based on mapping a TB to the non-contiguous BWP 645 that includes SB0 and SB1.

As noted above, channel bonding and carrier aggregation are both techniques that can be used to map a TB over multiple CCs that are included in an aggregated bandwidth. The aggregated bandwidth comprises multiple carriers (e.g., CCs), which can be contiguous or non-contiguous in the frequency domain. In the example of carrier aggregation (CA), multiple carriers or frequency channels are combined into an aggregated bandwidth while the individual carriers remain separately scheduled. For example, each carrier in a CA configuration is independently scheduled and modulated, and maintains a respective (e.g., per-carrier) PHY layer configuration indicative of PHY parameters such as cyclic prefix length, subcarrier spacing (SCS), timing, etc. Wireless communications performed using carrier aggregation are implemented using separate (e.g., per-carrier) RF chains and processing by the UE and/or network entity (e.g., base station, gNB, etc.).

Channel bonding can be used to provide an aggregated bandwidth of multiple CCs, which can be the same as the CCs in the example CA configuration. In a channel bonding configuration, the multiple CCs of the aggregated bandwidth are implemented or configured as a single logical entity (e.g., a single wideband channel over the aggregated bandwidth, with scheduling and PHY layer configuration implemented for the single logical wideband channel rather than for each CC). Both carrier aggregation and channel bonding can be used to perform wireless communications where a transport block (TB) is mapped over some, or all, of the respective carriers within the aggregated bandwidth. For example, the TB can include a plurality of code blocks, where each code block is a subset of the TB. Transmission and reception can be performed at the TB level, the CB level, and/or a level of the data information represented within a CB (e.g., bit-level, symbol-level, etc.).

Mapping a TB over multiple CCs of an aggregated bandwidth can be performed using one or more interleavers, multiplexers, etc. For example, an interleaver can be configured to use an interleaving configuration to map and allocate respective portions of a TB (e.g., one or more CBs, or portions thereof) to different CCs of the aggregated bandwidth. In some examples, an interleaving configuration may indicate an interleaving pattern, which corresponds to repeated logic applied by the interleaver to distribute data components of an input TB to different CCs of the aggregated bandwidth, with the mapping between different portions of the input to particular CCs of the aggregated bandwidth indicated based on the interleaving pattern and/or the interleaving configuration.

Channel bonding implementations can be associated with a corresponding hardware impact for a UE, network entity, network device, etc., that will perform wireless communications using the channel bonding implementation(s). For example, additional RF and other hardware resources may be provided in UEs and other devices configured to support channel bonding, where the hardware impact is based on factors such as the number of CCs within the aggregated bandwidth for the channel bonding configuration, the size (e.g., bandwidth) of the CCs within the aggregated bandwidth for the channel bonding configuration, and/or the separation (e.g., in the frequency domain, for example in units of REs, sub-carriers, tones, etc.) between adjacent CCs within the aggregated bandwidth for the channel bonding configuration.

In some examples, channel bonding can be used to provide generalization of one or more diversity techniques for the wireless communication network. Diversity techniques may also be referred to as diversity schemes, and may be used to improve signal reliability, reduce fading, etc., to increase the robustness and/or reliability of signals transmitted and received in the wireless communications network. Diversity scheme techniques can be implemented to provide redundancy across different domains (e.g., time domain diversity, frequency domain diversity, spatial diversity, polarization diversity, code diversity, etc.). Diversity schemes can include transmit diversity schemes and/or receiver diversity schemes. Channel coding can provide generalization of diversity schemes to apply across multiple CCs (e.g., based on applying diversity schemes configured for use within a single carrier, to the aggregated bandwidth using channel bonding of multiple CCs into a virtual carrier). For example, HARQ-based time interleaving across CCs can be implemented for aggregated bandwidths using channel bonding. In another example, frequency interleaving across CCs can be implemented for an aggregated bandwidth using channel bonding. Various other diversity schemes, coding techniques, etc., may be used across CCs, based on applying the other diversity schemes or coding techniques to the single logical carrier (e.g., virtual carrier) comprised by the aggregated bandwidth using channel bonding for a plurality of CCs.

In some cases, frequency interleaving (FI) across CCs may be used to increase diversity for channels that are relatively flat over the CCs. For example, channels that are relatively flat over the CCs can correspond to channels with slowly varying channel conditions for different CCs over time, and/or can refer to channels with small magnitudes of channel condition variations for different CCs. An example of channels that can be relatively flat over CCs is broadcast channels, which can have the same size within a geographical area. In some examples, frequency interleaving across CCs can additionally be used to improve network coverage, with improved network coverage corresponding to increased reliability of reception.

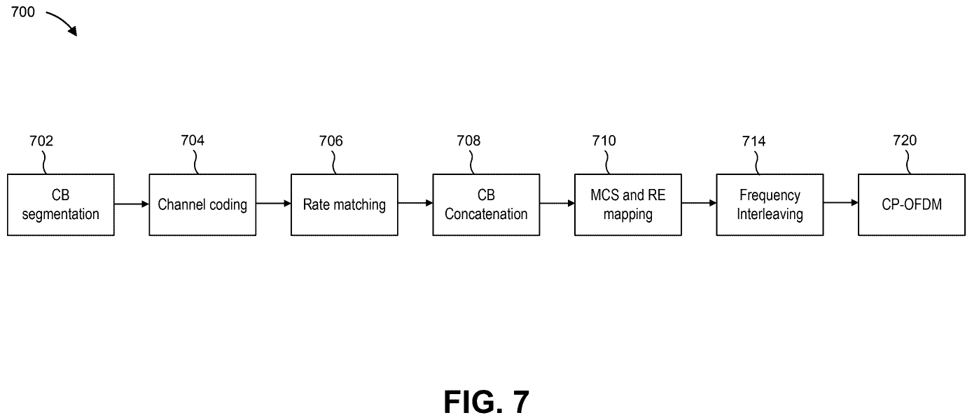

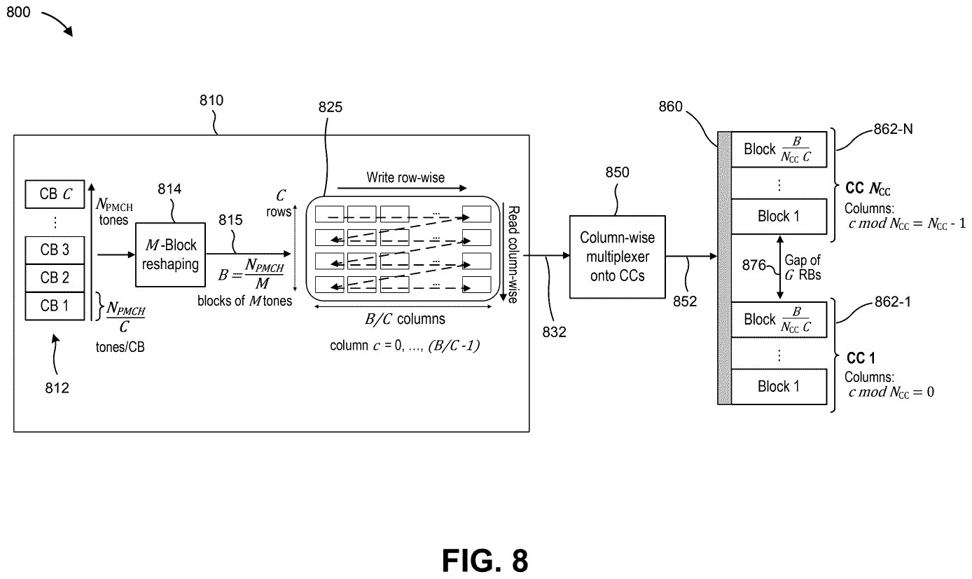

FIG. 7 is an example of a transmission scheme 700 of a wireless communication network configured to implement frequency interleaving, in accordance with some examples. In some aspects, the transmission scheme 700 may correspond to a 5G NR wireless network, for example 3GPP Rel. 16 and beyond. 3GPP Rel. 16 provides a frequency interleaving block 714, which can be used in the transmission chain of the scheme 700 after the MCS and RE mapping block 710. In one illustrative example, the frequency interleaving block 714 can be configured to perform intra-CC frequency interleaving (e.g., frequency interleaving of a plurality of tones corresponding to a set of CBs scheduled for transmission on one or more carriers, where the interleaving is applied for individual CCs). FIG. 8 illustrates an example of an intra-CC frequency interleaving block 810, which in some cases can be the same as or similar to the frequency interleaving block 714 of FIG. 7.

As noted above, FIG. 7 illustrates an example transmission chain corresponding to a transmission scheme 700 using frequency interleaving. The transmission chain of FIG. 7 can be implemented by a UE and/or a network entity (e.g., base station, gNB, etc.). At block 702, the transmission chain includes CB segmentation, which may be performed to divide one or more TBs into a larger number of CBs, where each of the CBs is smaller than a TB (e.g., each CB is a subset of a TB, etc.). CB segmentation 702 may be performed when the TB size is greater than the maximum CB size supported for the transmission scheme 700. For example, CB segmentation 702 can be performed when the TB size is larger than the maximum CB size supported by a low-density parity check (LDPC) code, etc.

At block 704, the transmission chain can perform channel coding of the segmented CBs obtained from the CB segmentation 702. For example, each CB may be encoded using a channel coding configuration, which may be an LDPC or other error correcting code (e.g., for examples where the channel is a data channel), and/or a polar code (e.g., for examples where the channel is a control channel), among various others. The channel coded CBs can be provided from the channel coding block 704 to a rate matching block 706 of the transmission scheme. The rate matching block 706 can be used to perform rate matching for the encoded bits (e.g., rate matching for the channel coded bits of each CB), where the rate matching block 706 performs rate matching configured to adapt the transmission to the available radio resources of the channel. The rate matching block 706 can perform various rate matching operations, which can include one or more of puncturing, repetition, etc., to match a required or configured code rate for the transmission.

The bits after rate matching 706 can be processed by a CB concatenation block 708, which concatenates the bits associated with each respective CB of the set of CBs back into a sequence of bits. The concatenated CBs in the sequence of bits can subsequently be processed by the MCS and RE mapping block 710, which takes the sequence of concatenated CB bits as inputs and performs mapping between groups of bits in the input sequence of bits to the physical resources available and/or scheduled for the transmission. The MCS and RE mapping block 710 can perform modulation according to a modulation coding scheme (MCS) configured for and/or associated with the transmission. For example, the MCS can be a signaled parameter, a network-configured parameter, etc. Different MCS, modulations, modulation orders, etc., may be used corresponding to the channel conditions. The MCS and RE mapping block 710 can perform modulation to generate a modulated symbol for groups of bits in the input sequence of bits to block 710 (e.g., subsets of bits within the input sequence of bits are modulated and mapped to corresponding modulation symbols included in the constellation diagram for the modulation being implemented). The MCS and RE mapping block 710 can perform RE mapping to map the modulated symbols onto physical resource blocks (PRBs) within the frequency grid of time-frequency resources (e.g., REs) allocated for or associated with the transmission.

The output of the MCS and RE mapping block 710 can be a plurality of modulated symbols corresponding to the input set of CBs (e.g., the CBs determined at block 702, etc.), and may indicate an initial RE mapping to allocate respective modulated symbols to particular PRBs and/or REs.

In examples where the transmitter chain of the transmission scheme 700 includes one or frequency interleavers and/or frequency interleaving operations, the frequency interleaving block 714 can be included after the MCS and RE mapping block 710. The frequency interleaving block 710 can perform frequency interleaving to improve (e.g., increase) the frequency diversity of the modulated symbols prior to transmission using the PRBs and/or REs of the resource grid. In some examples, the frequency interleaving block 714 can perform frequency interleaving based on applying a random and/or configured interleaving pattern to permute the ordering and/or arrangement of the modulated symbols across different subcarriers (e.g., tones) of a carrier (e.g., CC) associated with the PRBs and REs available for the transmission. In examples where the frequency interleaver block 714 applies the permutations to re-order the symbols across different subcarriers or tones of a single carrier (e.g., CC), the frequency interleaver 714 can be referred to as an “intra-CC interleaver.” Intra-CC interleaving by the frequency interleaving block 714 can be used to mitigate frequency-selective fading and narrowband interference for the transmission, among various other mitigations. In some examples, frequency interleaving can increase the error resilience for the transmission, based on spreading the information of the transmission (e.g., the modulated symbols and/or associated tones or sub-carriers for the modulated symbols, etc.) across a wider bandwidth than an initial bandwidth corresponding to the PRBs and REs used in the RE mapping at block 710.

In examples where the transmitter chain of FIG. 7 includes the frequency interleaving block 714, the interleaved sequence of symbols or tones can be output from the frequency interleaver 714 to cyclic prefix (CP)-orthogonal frequency division multiplexing (CP-OFDM) block 720, which may be configured to apply OFDM modulation to convert the frequency-domain data from the frequency interleaver 714 and/or MCS and RE mapping block 710 into time-domain waveforms that can be transmitted over the channel. For example, the CP-OFDM block 720 can apply an inverse fast Fourier transform (IFFT) to generate corresponding OFDM symbols from the input frequency domain information. The CP-OFDM block 720 can be configured to insert a cyclic prefix (CP) to mitigate inter-symbol interference. The output of the CP-OFDM block 720 can be a time-domain waveform that can be transmitted over the air, using the channel and corresponding resources, REs, etc., thereof.

FIG. 8 is a diagram illustrating an example of frequency interleaving 800 implemented using a first interleaver 810 and a second interleaver 850. In some examples, the frequency interleaving 800 can correspond to the frequency interleaving block 714 of FIG. 7. In some cases, the frequency interleaving block 714 of FIG. 7 can include and/or correspond to the first interleaver 810 of FIG. 8. In some cases, the frequency interleaving block 714 of FIG. 7 can include and/or correspond to the first interleaver 810 and the second interleaver 850 of FIG. 8.

In one illustrative example, the first interleaver 810 can be configured as a sub-block interleaver for performing frequency interleaving at the subcarrier (e.g., tone) level. Subblock interleaving using the first interleaver 810 can be performed to reorder a plurality of tones allocated on the respective REs within a single carrier (e.g., CC). In some aspects, the first interleaver 810 may also be referred to as an intra-CC interleaver. For example, the first interleaver 810 can perform intra-CC interleaving based on using an interleaving configuration that depends on the set of input CBs 812, but does not depend on or use parameter associated with the set of CCs that will be used for transmission.

In some aspects, the first interleaver 810 is an intra-CC interleaver, based on the interleaving configuration being implemented independent from the channel and/or carriers (e.g., CCs) that will be used for transmission (e.g., the intra-CC interleaving configuration of the first interleaver 810 receives as input a plurality of tones arranged in a first sequence that corresponds to the set of CBs 812, performs intra-frequency interleaving, and outputs a second, interleaved sequence that is different from the first sequence. The second, interleaved sequence is not mapped or allocated to the particular CCs or REs for transmission, based on being in sequence form.

In one illustrative example, the set of input CBs 812 comprises a plurality of tones corresponding to a plurality of CBs (e.g., CB 1, CB 2, CB 3, . . . , CB C, etc.). Each tone of the plurality of tones corresponds to one CB of the plurality of CBs. For example, a first subset of the plurality of tones corresponds to CB 1, a second subset of the plurality of tones corresponds to CB 2, a third subset of the plurality of tones corresponds to CB 3, . . . , and a C^{th} subset of the plurality of tones corresponds to CB C, etc.

The input plurality of tones to the first interleaver 810 can include a total quantity of tones (e.g., number of tones) represented by N_{PMC}H. The term C is equal to the number of CBs included in the plurality of input CBs 812. In examples where the plurality of CBs 812 each include the same number of tones, the number of tones per CB is given by

$$\frac{{N}_{PMCH}}{C} .$$

In some examples, the sequence of the plurality of tones corresponding to the set of CBs 812 can be obtained from the MCS and RE mapping block 710 of FIG. 7 (e.g., the plurality of tones corresponding to the set of CBs 812 can be generated by modulating the respective bits of each CB 812 and performing mapping to the modulation symbols of the constellation diagram, and performing RE mapping of the modulated symbols, as noted above for MCS and RE mapping block 710 of FIG. 7).

The sequence of the plurality of tones N_{PMCH} corresponding to the C CBs in the set of CBs 812 can be provided to a block reshaping operation 814, which can be used to divide the sequence of N_{PMCH} tones into blocks (e.g., groups, subsets, etc.) of a configured number of tones M within each block. The block reshaping 814 can also be referred to as M-block reshaping, based on dividing the input sequence of the plurality of tones N_{PMCH} into an output set of blocks 815 that each comprise M tones of the plurality of tones N_{PMCH}.

The output set of blocks 815 can comprise a total number of blocks B, where the output set of blocks 815 includes

$$B = \frac{{N}_{PMCH}}{M}$$

blocks of M tones each. The blocks of tones, B, can be provided to a sub-block interleaver 825 as a sequence of blocks (e.g., block B₁ tones, block B₂ tones, block B₃ tones, . . . , etc.). The subblock interleaver 825 can be configured to perform intra-CC interleaving using an interleaving pattern (e.g., interleaving configuration) corresponding to writing the input sequence of blocks 815 in an order starting from the top left of the top row of the interleaver 825, proceeding horizontally across the top row of the interleaver 825 and moving down to the top left of the row second from the top, and continuing to write the sequence of blocks 825 row-wise (e.g., horizontally across the interleaver 825) until reaching the bottom right position of the last row of the interleaver 825. The pattern with which the interleaver 825 writes the input sequence of blocks 815 can be referred to as a row-wise write operation (e.g., write row-wise).

Interleaved blocks of tones can subsequently be read from the subblock interleaver 825 vertically by column (e.g., column-wise read) to obtain the interleaved output comprising an interleaved sequence of the blocks of tones. In some aspects, the size or dimensions of the subblock interleaver 825 can be configured according to the M-block reshaping 814 and the set of CBs 812. For example, the number of rows used by the subblock interleaver 825 can be equal to C, the number of CBs 812. The number of columns used by the subblock interleaver 825 can be equal to

$$\frac{B}{C} .$$

The subblock interleaver 825 has dimensions that include a total of to

$$\frac{B}{C} \cdot C = B$$

different positions for reading and writing a respective block of tones from the input sequence 815 of B blocks of tones. The rows of the interleaver 825 can be indexed according to C (e.g., row 1, row 2, . . . , row C−1, row C). The columns of the interleaver 825 can be indexed according to column

$$c = ( 0 , … , \frac{B}{C} - 1 ) .$$

In an illustrative example of the row-wise write, column-wise read interleaving configuration that can be used for the subblock interleaver 825, the input sequence 815 of blocks of tones can comprise the sequence {B₁, B₂, B₃, B₄, B₅, B₆, B₇, B₈, B₉}, where each of the nine blocks includes M tones corresponding to the set of CBs 812. For a value of C=3 respective CBs in the set of CBs 812, the dimensions used for the grid of block positions in the subblock interleaver 825 are 3×3.

Using the row-wise write operation to write the input sequence 815 of blocks of tones to the configured 3×3 subblock interleaver 825, the nine blocks of tones received as the input sequence 815 can be written row-wise across the interleaver. The state of the subblock interleaver 825 after the last input block of tones is written can be given as:

$$\begin{matrix}{B}_{1} & {B}_{2} & {B}_{3} \\ {B}_{4} & {B}_{5} & {B}_{6} \\ {B}_{7} & {B}_{8} & {B}_{9}\end{matrix}$$

The interleaved sequence for the blocks 815 is obtained based on reading column-wise from the subblock interleaver 825, starting from the top left block position to obtain the interleaved sequence of blocks {B₁, B₄, B₇, B₂, B₅, B₈, B₃, B₆, B₉}

In examples of frequency interleaving comprising intra-CC frequency interleaving, the interleaved sequence of blocks can be used to allocate the plurality of tones N_{PMCH} to a corresponding carrier (e.g., CC). In intra-CC interleaving, the bandwidth of the tones in the input CBs 812 is the same as the allocated bandwidth on the single carrier used for the interleaved sequence output by the subblock interleaver 825.

In examples where channel bonding is used (e.g., PHY/MAC bonding), multiple CCs are configured as a single logical entity (e.g., a single virtual carrier). The intra-CC interleaving scheme may experience degradation when attempting to allocate the plurality of tones N_{PMCH} across the aggregated bandwidth of the virtual carrier according to the interleaved block sequence, based on the virtual carrier appearing as a single logical entity while including non-contiguous CCs that have gaps in frequency between the different CCs within the aggregated bandwidth.

In one illustrative example, the systems and techniques described herein can be used to perform inter-CC interleaving of the intra-CC interleaved sequence output by the subblock interleaver 825. The inter-CC interleaving can be used to allocate the plurality of tones N_{PMCH} for the set of CBs 812 across the entire bandwidth of the aggregated bandwidth associated with the channel bonding virtual carrier. For example, the interleaved sequence of blocks of tones 832 can be generated by the subblock interleaver 825, as noted above, and can be provided as input to a column-wise multiplexer 850 configured to distribute (e.g., allocate) tones of the CBs 812 onto respective REs available for transmission within each CC of a set of multiple CCs included in an aggregated bandwidth 860 associated with channel bonding. The aggregated bandwidth 860 includes multiple carriers (e.g., CCs), for example a first carrier CC 1 (e.g., 862-1) comprising a first quantity of REs allocated for transmission of each CB, . . . , and an N^{th} carrier CC N_{CC} (e.g., 862-N) comprising an N^{th} quantity of REs allocated for transmission of each CB. The different carriers within the aggregated bandwidth 860 may have the same number of REs as other carriers within the aggregated bandwidth 860, and/or may have different numbers of REs from other carriers within the aggregated bandwidth 860.

In an illustrative example, intra-CC and inter-CC frequency interleaving can be performed using the interleaving configuration 800 of FIG. 8 for an aggregated bandwidth 860 that includes two CCs (e.g., N_{CC}=2). For example, using a 200/800 numerology, Td2Fd2 pilot pattern, and 4,800 PMCH tones per symbol corresponds to 20,616 bits of TBs, with four CBs of 6,144 bits input block size. The number of PMCH tones per CB is 2,400 tones, measured over two CCs (e.g., 862-1, 862-N) of 4,800 tones each.

The tone indexes for the plurality of tones N_{PMC}H, before and after interleaving by the intra-CC subblock interleaver 825, can be represented as:
Tone indexes (before intra-CC FI): 0, 1, 2, . . . , 9599
Tone indexes (after intra-CC FI): 0, 2400, 4800, 7200, 1, 2401, 4801, 7201, 2, 2402, 4802, 7202, 3, 2403, 4803, 7203, . . . , 2399, 4799, 7199, 9599

The column-wise multiplexer 850 can receive the intra-CC interleaved tones 832 as input, and can output the inter-CC interleaved tones 852 for multiplexing onto the respective REs of the respective CCs within the aggregated bandwidth 860 (e.g., CC 1 862-1, CC N_{CC} 862-N, etc.). The inter-CC interleaved tones 852 can be multiplexed as blocks of tones, with consecutive blocks in the sequence of tone indexes 832 from the columns of the intra-CC interleaver being allocated to REs of different CCs. For example, the tone indexes above can be column-wise multiplexed by block size M onto the CCs 862-1 and 862-N by the inter-CC multiplexer 850 as given below (e.g., with each block of M=4 tones indicated as the four tone indexes enclosed within a pair of brackets [ ]):

### Tone Indexes (Column-Wise Multiplexed):

$$Block 1 of CC 1 = [ 0 , 2400 , 4800 , 7200 ] ; \\ Block 1 of CC 2 = [ 1 , 2401 , 4801 , 7201 ] ; \\ Block 2 of CC 1 = [ 2 , 2402 , 4802 , 7202 ] ; \\ Block 2 of CC 2 = [ 3 , 2403 , 4803 , 7203 ] ; \\ … ; \\ Block \frac{{N}_{tones}}{{N}_{CB}} - 1 of CC 2 [ 2399 , 4799 , 7199 , 9599 ]$$

The column-wise multiplexer for inter-CC interleaving (e.g., 850) onto the CCs 862-1, . . . , 862-N can allocate the blocks of tones to REs within the set of CCs, with each CC having a respective quantity of blocks of tones shown in FIG. 8 as block 1, . . . , block

$$\frac{B}{{N}_{CC} C} .$$

For example, the sequence of column-wise blocks of intra-CC interleaved tone indexes can be multiplexed and allocated onto the set of CCs in the aggregated bandwidth 860 to separate the consecutive tones within a CB 812 by an inter-CC frequency gap G 876, for example representing a gap in units of frequency (e.g., RBs, REs, subcarriers, etc.). For example, tone ‘0’ and tone ‘1’ are consecutive tone indices, and are separated by the frequency gap G 876 based on tone ‘0’ being included within Block 1 of CC 1 862-1 and tone ‘1’ being included within Block 1 of CC N_{CC} 862-N (e.g., CC 2, in the example where N_{CC}=2).

Columns of the intra-CC subblock interleaver 825 allocated to REs of CC1 862-1 can be the columns with column index c that satisfies c mod N_{CC}=0. Columns of the intra-CC subblock interleaver 825 allocated to REs of CC2 862-N can be the columns with column index c that satisfies c mod N_{CC}=N_{CC}−1.

A receiver can be configured to perform de-interleaving using a first de-interleaver and a second de-interleaver, where the first de-interleaver corresponds to and is configured to de-interleave the inter-CC interleaving implemented by the column-wise multiplexer 850. The second de-interleaver corresponds to and is configured to de-interleave the intra-CC interleaving implemented by the intra-CC subblock interleaver 825.

For example, with a 200/800 numerology, Td2Fd2 pilot pattern, 4,800 PMCH tones per symbol, 20,616 bits of TBs, N_{CB}=4 CBs of 6,144 bits input block size, and 2,400 PMCH tones per CB, the tone indexes before intra-CC frequency interleaving 825 are given as 0, 1, . . . , 9599 (e.g., x_{No-FI} [0], . . . x_{No-FI} [9599] where x_{No-FI}[i] is the tone having index i before intra-CC frequency interleaving (FI) 825).

The tone indexes after intra-CC frequency interleaving are then: Block 0=[0, 2400, 4800, 7200]; Block 1=[1, 2401, 4801, 7201]; . . . ;

$$Block \frac{{N}_{tones}}{{N}_{CB}} - 1 = [ 2399 , 4799 , 7199 , 9599 ] .$$

In some aspects, the inter-CC interleaver 850 is configured to perform the inter-CC frequency interleaving based on taking the output sequence 832 of the intra-CC frequency interleaver 825, splitting the intra-CC FI output sequence 832 into

$$\frac{{N}_{tones}}{{N}_{CB}} blocks$$

of N_{CB} tones per block, and mapping the bth block to the (b mod N_{CC}) carrier, where carriers are numbered (e.g., indexed) as CC 0, CC 1, . . . , CC N_{CC}−1, and where each carrier has

$$\frac{{N}_{tones}}{{N}_{CC}} tones .$$

In the above example with two CCs 862-1, 862-N (e.g., N_{CC}=2), the number of tones Nₜₒₙₑₛ=9,600 and is measured across the two CCs of 4,800 tones each (e.g., 4,800 tones corresponding to CC 862-1 and 4,800 tones corresponding to CC 862-N of FIG. 8). The value of the number of blocks is then

$$\frac{{N}_{tones}}{{N}_{CB}} = \frac{9 , 600}{4} = 2 , 400 blocks of {N}_{CB} = 4 tones per block .$$

The first carrier CC 862-1 is allocated the even-numbered block indexes by the column-wise multiplexing performed by the inter-CC interleaver 850, and corresponds to the 1,200 even block indexes (0, 2, . . . , 2398). The second carrier CC 862-N is allocated. The odd-numbered block indexes by the column-wise multiplexing performed by the inter-CC interleaver 850, and corresponds to the 1,200 odd block indexes (1, 3, . . . , 2399).

The tone indexes for CC 1 in y₁[k] after the inter-CC frequency interleaver 850 are then: [0, 2400, 4800, 7200]; [2, 2402, 4802, 7202]; . . . ; [2398, 4798, 7198, 9598].

The tone indexes for CC 2 in y₂[k] after the inter-CC frequency interleaver 850 are: [1, 2401, 4801, 7201]; [3, 2403, 4803, 7203]; . . . ; [2399, 4799, 7199, 9599].

To de-interleave the inter-CC interleaver 850 and intra-CC interleaver 825 operations, the corresponding de-interleaver can be configured to perform de-interleaving for the

$${N}_{tones}^{( c )}$$

received per CC (e.g., received by the receiver that includes the de-interleaver, etc.). The total number of tones received across the CCs of the aggregated bandwidth 860 is

$${N}_{tones} = {\sum }_{c = 0}^{{N}_{CC} - 1} {N}_{tones}^{( c )} .$$

A first de-interleaving operation can be used to cause the de-interleaver to generate, for each CC c=0, . . . , N_{CC}−1, a corresponding matrix representation Y_{c} of the respective vectors of tones

$${y}_{c} = ⌈ {y}_{c} [ 0 ] , {y}_{c} [ 1 ] , … , {y}_{c} [ {N}_{tones}^{( c )} - 1 ] ]$$

received in the CC c. For example, the de-interleaver can write the vectors of tones y_{c} row-wise into the matrix Y_{c} for each CC c, to obtain:

$${Y}_{c} = [ \begin{matrix}{y}_{c} [ 0 ] & {y}_{c} [ 1 ] & ⋯ & {y}_{c} [ {N}_{CB} - 1 ] \\ {y}_{c} [ {N}_{CB} ] & {y}_{c} [ {N}_{CB} + 1 ] & ⋯ & {y}_{c} [ 2 {N}_{CB} - 1 ] \\ ⋮ & ⋮ & ⋱ & ⋮ \\ {y}_{c} [ ( \frac{{N}_{tones}^{( c )}}{{N}_{CB}} - & {y}_{c} [ ( \frac{{N}_{tones}^{( c )}}{{N}_{CB}} - & ⋯ & {y}_{c} [ ( \frac{{N}_{tones}^{( c )}}{{N}_{CB}} - 1 ) {N}_{CB} + \\ 1 ) {N}_{CB} ] & 1 ) {N}_{CB} + 1 ] & & {N}_{CB} - 1 ]\end{matrix} ]$$

A second de-interleaving operation can be used to obtain the inter-CC de-interleaved tones. For example, the inter-CC de-interleaved tones can be obtained based on row-wise reading the entries from the respective matrix Y_{c} for each CC c, where the row-wise reading of each matrix Y_{c} is a multiplexed row-wise read operation that reversed the multiplexed allocation performed by the inter-CC interleaver 850. For example, inter-CC de-interleaved tones can be read for each CC c from the corresponding matrix Y_{c} according to: for each row [Y₀]_{{j,:}}, . . . , [Y_{N}_{_{CC}}]_{{j,:}}, the different entries are read and concatenated such that the j^{th} row [Y_{c}]_{{j,:}} is not read until the j^{th} row [Y_{c′}]_{{j,:}} has been read, for c′<c.

For the example values above (e.g., 200/800 numerology, Td2Fd2 pilot pattern, 4,800 PMCH tones per symbol) and with the same values of the tone indexes received for CC 1 in y₁[k]: [0, 2400, 4800, 7200]; [2, 2402, 4802, 7202]; . . . ; [2398, 4798, 7198, 9598], and the same values of the tone indexes received for CC 2 in y₂[k]: [1, 2401, 4801, 7201]; [3, 2403, 4803, 7203]; . . . ; [2399, 4799, 7199, 9599], the de-interleaving process described above can be performed for each CC having

$${N}_{tones}^{( c )} = 4800 tones ,$$

corresponding to the total number of tones Nₜₒₙₑₛ=9600 tones received as input to the de-interleaving process across the two CCs (e.g., CC 1 862-1 and CC 2 862-N).

The first de-interleaving operation generates the matrix Y₁ for de-interleaving associated with the first carrier CC 1, where the matrix Y₁ is generated by performing a row-wise write of the corresponding vectors of tones y₁=[y₁[0], y₁[1], . . . , y₁[4799]] that are received for CC 1. The matrix Y₂ for de-interleaving associated with the second carrier CC 2 is generated by performing a row-wise write of the corresponding vectors of tones y₂=[y₂ [0], y₂[1], . . . , y₂[4799]] received for CC 2. The generated matrices for the set of CCs (e.g., CC1 and CC2) are given as:

$${Y}_{1} = [ \begin{matrix}{y}_{1} [ 0 ] & {y}_{1} [ 1 ] & {y}_{1} [ 2 ] & {y}_{1} [ 3 ] \\ {y}_{1} [ 4 ] & {y}_{1} [ 5 ] & {y}_{1} [ 6 ] & {y}_{1} [ 7 ] \\ ⋮ & ⋮ & ⋱ & ⋮ \\ {y}_{1} [ 4796 ] & {y}_{1} [ 4797 ] & y [ 4798 ] & {y}_{1} [ 4799 ]\end{matrix} ]$$

$${Y}_{2} = [ \begin{matrix}{y}_{2} [ 0 ] & {y}_{2} [ 1 ] & {y}_{2} [ 2 ] & {y}_{2} [ 3 ] \\ {y}_{2} [ 4 ] & {y}_{2} [ 5 ] & {y}_{2} [ 6 ] & {y}_{2} [ 7 ] \\ ⋮ & ⋮ & ⋱ & ⋮ \\ {y}_{2} [ 4796 ] & {y}_{2} [ 4797 ] & {y}_{2} [ 4798 ] & {y}_{2} [ 4799 ]\end{matrix} ]$$

The tone indexes for the matrices Y₁ and Y₂ are indexed on a per-CC basis, with a respective tone index value for each one of the 4,800 tones in each CC. The tone indexes can be repeated (e.g., shared or common index values, etc.) across the respective matrices for different CCs. For example, the matrices Y₁ and Y₂ both include an tone index of ‘0’ to identify their respective first tone. The tone index of ‘0’ in the CC 1 matrix Y₁ corresponds to a different underlying tone than the same tone index of ‘0’ when used in the CC 2 matrix Y₂. For example, in the CC 1 matrix Y₁, the tone index ‘0’ is used to index the CC 1 vector of tones y₁[0], which is absolute tone index 0 in the sequence of the total number of tones Nₜₒₙₑₛ=9600 received across the two CCs, CC 1 and CC2. In the CC 2 matrix Y₂, the tone index ‘0’ is used to index the CC 2 vector of tones y₂[0], which is absolute tone index 1 in the sequence of the total number of tones Nₜₒₙₑₛ=9600.

The corresponding intra-FI indexes for each entry in the CC 1 matrix Y₁ are given below within matrix I₁, and the corresponding intra-FI indexes for each entry in the CC 2 matrix Y₂ are given below within matrix I₂:

$${I}_{1} = [ \begin{matrix}0 & 2400 & 4800 & 7200 \\ 2 & 2402 & 4802 & 7202 \\ ⋮ & ⋮ & ⋱ & ⋮ \\ 2398 & 4798 & 7198 & 9598\end{matrix} ]$$

$${I}_{2} = [ \begin{matrix}1 & 2401 & 4801 & 7201 \\ 3 & 2403 & 4803 & 7203 \\ ⋮ & ⋮ & ⋱ & ⋮ \\ 2399 & 4799 & 7199 & 9599\end{matrix} ]$$

The second de-interleaving operation can be performed by reading the first row from Y₁, and concatenating with the first row read from Y₂; reading the second row from Y₁, and concatenating with the second row read from Y₂; and repeating the process for each row in Y₁ and Y₂ to obtain a vector z of inter-CC de-interleaved tones (e.g., the vector z of inter-CC de-interleaved tones after the first de-interleaver is the same as the vector or sequence of intra-CC interleaved tones 832 at the interleaver side provided at the output of the intra-CC interleaver 825 and the input of the inter-CC interleaver 850). For example, the inter-CC de-interleaved tones can be obtained at the de-interleaver side as the vector:

$$z = [ {y}_{1} [ 0 ] , {y}_{1} [ 1 ] , {y}_{1} [ 2 ] , {y}_{1} [ 3 ] , {y}_{2} [ 0 ] , {y}_{2} [ 1 ] , {y}_{2} [ 2 ] , {y}_{2} [ 3 ] … , {y}_{1} [ 4796 ] , \\ {y}_{1} [ 4797 ] , {y}_{1} [ 4 \; 798 ] , {y}_{1} [ 4799 ] , {y}_{2} [ 4796 ] , {y}_{2} [ 4797 ] , {y}_{2} [ 4798 ] , {y}_{2} [ 4799 ]$$

The vector z of inter-CC de-interleaved tones contains the intra-CC interleaved tones (e.g., inter-CC interleaving has been reversed, but intra-CC interleaving has not been reversed). The vector z can be provided to an intra-CC frequency de-interleaver that is configured to de-interleave the intra-CC interleaving applied by the intra-CC subblock interleaver 825 of FIG. 8.

In some examples, the systems and techniques can be used to provide an interleaving configuration for aggregated bandwidths, where the interleaving configuration indicates enablement or non-enablement (e.g., disablement) of the inter-CC frequency interleaving. For example, the interleaving configuration can indicate enablement of inter-CC frequency interleaving, to cause a transmitter to use the inter-CC interleaver 850 of FIG. 8. The interleaving configuration can indicate non-enablement or disablement of the inter-CC frequency interleaving, to cause a transmitter to not use the inter-CC interleaver 850 of FIG. 8 (e.g., perform no frequency interleaving by skipping intra-CC interleaver 825 and inter-CC interleaver 850; or perform only intra-CC interleaving using intra-CC interleaver 825 and not using inter-CC interleaver 850).

In some cases, inter-CC frequency interleaving may be used in combination with one or more Multimedia Broadcast Multicast Service (MBMS) services associated with a Multicast Broadcast Single Frequency Network (MBSFN) Area ID. In one illustrative example, the semi-static configuration of one or more MBMS services associated with the MBSFN Area ID can be used to provide an indication of the interleaving configuration for inter-CC FL. For example, the semi-static configuration of MBMS service(s) associated with the MBSFN Area ID can be used to provide an inter-CC frequency interleaving configuration to the UE that indicates that services within the MBSFN Area that are associated with multiple frequency resources (e.g., cells, carrier, channels, etc.) are frequency interleaved by an inter-CC interleaver (e.g., such as inter-CC interleaver 850 of FIG. 8, etc.).

In some aspects, the inter-CC interleaving configuration can be signaled using a multicast control channel (MCCH) message. For example, the inter-CC frequency interleaving configuration and/or indication can be included in the MBSFN-AreaConfiguration within an MCCH message. In one illustrative example, the inter-CC interleaving configuration and/or indication is included in MBSFN-AreaInfo IE signaling. For example, the inter-CC interleaving configuration and/or indication may be indicated by and/or included within Physical Multicast Channel (PMCH) configuration information. For example, an MBSFN-AreaInfo IE signaling-based technique can include the inter-CC interleaving configuration and/or indication within the PMCH-Config as:

```
PMCH-Config-r9 ::= SEQUENCE {
      sf-AllocEnd-r9 INTEGER (0..1535),
      dataMCS-r9 INTEGER (0..28),
      mch-SchedulingPeriod-r9 ENUMERATED {
      rf8, rf16, rf32, rf64, rf128, rf256, rf512, rf1024},
      mtch-InterCCIntlvEnabled ENUMERATED {0, 1}
      ...
}
```

In another illustrative example, the inter-CC interleaving configuration and/or indication can be included in a Multicast Channel (MCH) Scheduling Information (MSI) Media Access Control (MAC) Control Element (MAC-CE). In some aspects, the MSI MAC-CE can be included in an MCCH message received by a UE or other network entity.

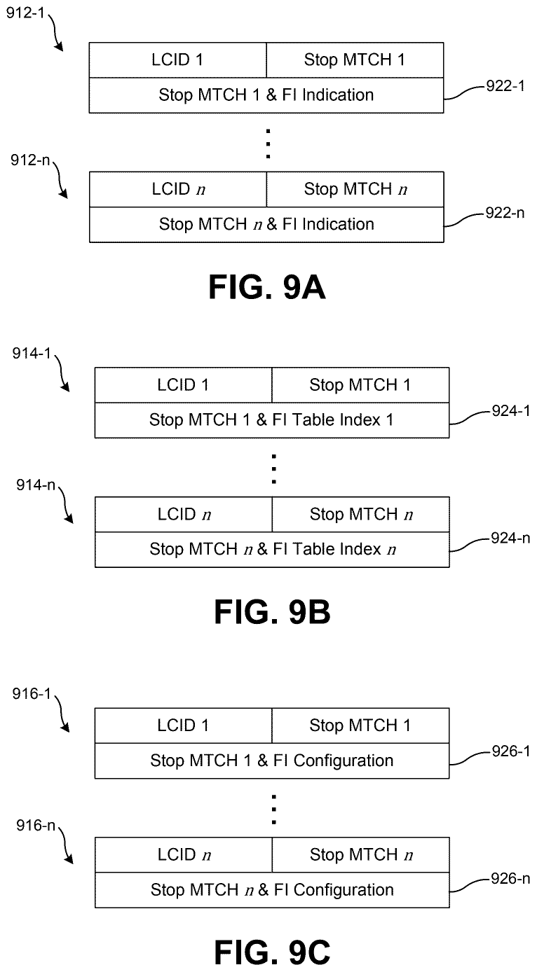

FIG. 9A illustrates an example of MSI MAC-CE signaling indicative of an inter-CC interleaving enablement indication, in accordance with some examples. For example, a first MSI MAC-CE 912-1 can include a corresponding LCID field (LCID 1), a corresponding stop MTCH field (Stop MTCH 1), and an FI indication field 922-1 that includes and/or is indicative of the inter-CC interleaving configuration. An n^{th} MSI MAC-CE 912-n can include a corresponding LCID field (LCID n), a corresponding stop MTCH field (Stop MTCH n), and an FI indication field 922-n that includes and/or is indicative of an n^{th} inter-CC interleaving configuration.

In some aspects, signaling the interleaving configuration for performing the inter-CC frequency interleaving can correspond to an increase in payload size. In one illustrative example, information indicative of the interleaving enablement or disablement can be transmitted and received using a first signaling, and a second signaling can be used to indicate one or more parameters for the interleaving configuration. For example, the separately signaled parameters for the interleaving configuration can include the interleaving size for the inter-CC interleaver, and the interleaving depth for the inter-CC interleaver. The inter-CC interleaver can be configured to perform the inter-CC interleaving using the configured interleaving size and the configured interleaving depth obtained from the signaling.

In some examples, the interleaving size and depth parameters for the inter-CC interleaver configuration can be signaled based on including respective indications of the interleaving size and depth parameter values in the MSI. In some aspects, different configurations of the values of the inter-CC interleaving configuration parameters can be enabled for each logical channel. In one illustrative example, different values of the interleaving size and the interleaving depth for the inter-CC interleaver can be indicated based on signaling of an index to a lookup table or other data structure configured to store corresponding values of the inter-CC interleaving parameters as pairs or tuples that are mapped to a respective index.

For example, the lookup table or other data structure can include a plurality of entries each mapped to an index, where each entry comprises a tuple {interleaving size, interleaving depth} of values for the inter-CC interleaving configuration parameters. To indicate the inter-CC interleaving configuration, a network entity can use the MSI to signal the configured index of a particular {interleaving size, interleaving depth} tuple of values that is selected for inter-CC frequency interleaving. In some aspects, the MSI can indicate a tuple index that is signaled in the MSI for a particular LCID that is associated with a respective service within the MBSFN Area. The {interleaving size, interleaving depth} parameter values mapped to the tuple index in the MSI can provide an inter-CC interleaving configuration that applies to the particular LCID and/or that applies to the particular service within the MBSFN Area for the particular LCID, etc.

FIG. 9B illustrates an example of MCI signaling indicative of an inter-CC interleaving configuration indicated using an index value corresponding to a particular configuration of one or more parameters for generating an interleaved tone sequence, in accordance with some aspects. A first example MSI 914-1 corresponds to a first LCID (LCID 1), and can include a field 924-1 that includes the tuple index for the configured interleaving size and interleaving depth parameters for the first LCID 1 and associated services within the MBSFN area. For example, the first MSI 914-1 includes the field 924-1 with a first index value to the lookup table or data structure (e.g., the field 924-1 includes and/or indicates FI Table Index 1). The value FI Table Index 1 within the field 924-1 can be used to signal the inter-CC interleaving configuration for LCID 1 and associated services for LCID 1 within the MBSFN area.

Additional MSIs can be used to signal tuple index values for respective inter-CC interleaving configurations for other LCIDs and associated services within the MBSFN area. For example, an n^{th} MSI 914-n corresponds to an n^{th} LCID (LCID n), and includes a field 924-n indicative of the tuple index FI Table Index n for the configured interleaving size and interleaving depth parameters for the n^{th} LCID n and associated services within the MBSFN area.

In another illustrative example, the tuple values can be signaled by the MSI itself (e.g., the MSI can include a field storing the respective values for the interleaving size and the interleaving depth of the particular inter-CC interleaving configuration that is used). For example, FIG. 9C illustrates examples of a first MSI 916-1 corresponding to a first LCID (LCID 1) and including a field 926-1 that includes an FI Configuration storing a value of the interleaving size and a value of the interleaving depth configured for the inter-CC frequency interleaver. An n^{th} MSI 916-n corresponds to an n^{th} LCID (LCID n) and includes a field 926-n with an FI Configuration storing a value of the interleaving size and a value of the interleaving depth configured for the inter-CC frequency interleaver. In some examples, the FI Configuration in fields 926-1, 926-n can store values that are the same as the tuples that may be stored in a lookup table or other data structure in the example of FIG. 9B. In some cases, the MSI can include the interleaving size and depth tuple values directly to reduce a total payload size of each MSI 916-1, . . . , 916-n. For example, for large quantities of unique tuples for different configurations of the inter-CC interleaving size and depth, the number of indexes used to uniquely identify each tuple is also relatively large and can be associated with a greater payload size. For example, the number of bits to signal a selected index from a total of 10,000 possible index values is more than the number of bits to signal a selected index from a total of 10 possible index values, etc. In some aspects, the MSI can use the field 926-1, 926-n to include the interleaving size and interleaving depth tuple values when the tuple values can be carried on fewer bits than would be needed to carry a corresponding index value to the same tuple if stored in a lookup table or other data structure.

In some examples, the inter-CC interleaving configuration information can be indicative of a block size used for the inter-CC interleaving. The block size for the inter-CC interleaving can be the same as the parameter C in FIG. 8, which corresponds to the number of CBs in the set of CBs 812 being interleaved, and also corresponds to the number of rows used in the intra-CC interleaver 825. Based on in the inter-CC interleaving block size C, the inter-CC interleaver 850 multiplexes

$$\frac{B}{{N}_{CC} C}$$

blocks of size C (e.g., each block including C tones) onto each respective CC of the multiple CCs within the aggregated bandwidth 860.

For example, the inter-CC interleaving block size may be equal to the number of CBs in the set of CBs 812, which can be explicitly indicated in the signaling of the inter-CC interleaving configuration information. In some cases, an inter-CC interleaving block size equal to the number of CBs may be signaled implicitly, for example as a default assumption applied by the UE in the absence of an explicit indication of a different value for the inter-CC interleaving block size. In examples where inter-CC interleaving is configured to use a block size that is not equal to the number of CBs, the inter-CC interleaving configuration can include an explicit indication of the block size to be used for the inter-CC frequency interleaving.

In some examples, inter-CC interleaving can be implemented for NR broadcast. In some examples, inter-CC interleaving can be implemented for NR multicast and/or NR unicast. In one illustrative example, for NR Multicast and Broadcast Services (IBS), a group-common (GC) downlink control information (DCI) can be used instead of the MSI to signal the inter-CC interleaving enablement indication and/or configuration. For example, the GC-DCI can be a GC-PDCCH, and cross-carrier scheduling can be used to indicate that inter-CC interleaving is enabled and/or has already been applied for the different carriers associated with the GC-DCI (e.g., GC-PDCCH) and the cross-carrier scheduling.

In some aspects, for NR multicast and/or unicast, an aggregated bandwidth associated with channel bonding may include a set of multiple CCs where different CCs may have a different number of RBs. For example, each CC of the set of multiple CCs in the aggregated bandwidth may have a different number of RBs. In another example, the aggregated bandwidth can include subsets of CCs that have the same number of RBs as other CCs within the same subset and a different number of RBs from the CCs not in the same subset (e.g., different number of RBs from the CCs in other subsets).

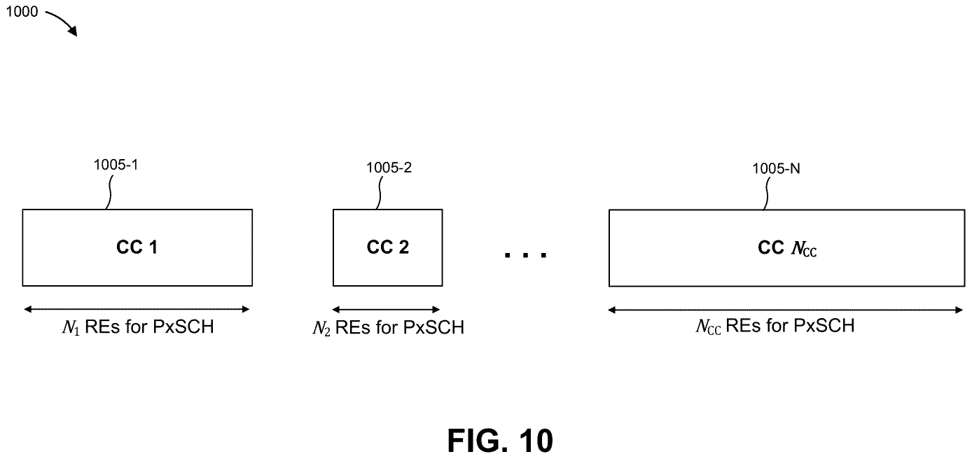

For example, FIG. 10 illustrates an example of a plurality of CCs 1000 having different respective numbers of REs per CC. A first CC 1005-1 (e.g., CC 1) includes a first quantity (e.g., number) of REs for PxSCH N₁ (e.g., where PxSCH represents various different types of Physical Shared Channels such as PUSCH, PDSCH, etc.). A second CC 1005-2 (e.g., CC 2) includes a second quantity of REs N₂, . . . , and an n^{th} CC 1005-N (e.g., CC N_{CC}) includes an n^{th} quantity of REs N_{CC}.

In some cases, channel conditions may not be known or may be unavailable or absent. Inter-CC frequency interleaving can be configured for carriers with different numbers of REs, based on configuring the network entity (e.g., base station, gNB, etc.) to split the total number of REs in each CC into different blocks for frequency interleaving. The network entity can split the total number of REs in each CC into a plurality of blocks for the frequency interleaving, where each block comprises s configured number of REs that is less than the total REs in the CC.

In some aspects, the block size can be equal to the number of CBs, as noted above. A configuration using a block size equal to the number of CBs may be implicitly signaled or configured as a default option in the absence of an explicit indication of a different block size. In some cases, the configuration using a block size equal to the number of CBs can be implicit based on rate-matching procedures implemented by the UE. In another example, the block size can be different from the number of CBs in the aggregated bandwidth, and can be signaled from the network entity to the UE. For example, the block size can be signaled using signaling selected from at least one of a UE-specific RRC, MAC-CE, or DCI. The block size can be selected and/or configured to correspond to inter-CC interleaving where the number of REs allocated to each CB in a CC is approximately constant across the different CBs, while also prioritizing the protection of systematic bits. For example, in some cases the number of REs can be different for the CCs, where each CC has some number of REs that is a multiple of the number of CBs to be mapped in the aggregated bandwidth (e.g., each CC can include a different number of REs, where each CC includes a number of REs that comprises an integer multiple of the number of CBs to be mapped for the inter-CC interleaving). In examples where the number of REs for each CC is an integer multiple of the number of CBs, the expression (#REs in the CC) mod C=0 evaluates as true.

In other examples, the number of REs can be different for the CCs and the number of REs in one or more (or each) of the CCs to be mapped is not a multiple of the number of CBs to be mapped. For example, when the number of REs in a CC is not a multiple of the number of CBs to be mapped, (#REs in the CC) mod C≠0. Instead, when the number of REs in the CC is not a multiple of the number of CBs to be mapped, the expression (#REs in the CC) mod C evaluates to a remainder quantity, where C>remainder>0.

In some aspects, the systems and techniques can determine priority or prioritization information for the set of CBs associated with the input tones to the inter-CC frequency interleaving. If some CBs are prioritized (e.g., have a higher priority than other CBs of the input set of CBs, etc.), the inter-CC interleaver 850 of FIG. 8 can implement a mapping algorithm to multiplex the tones for the set of CBs onto the CCs of the aggregated bandwidth, where the mapping algorithm is configured to first map the tones corresponding to higher priority CBs, before subsequently mapping the remaining tones corresponding to lower priority and/or non-high priority CBs. In some cases, the mapping performed by the inter-CC interleaver 850 can be configured to map the tones of the CBs in descending priority order, where the mapping follows the column-wise readout sequence from the intra-CC interleaver 825 when mapping the tones from CBS having equal priority. Mapping tones associated with higher priority or prioritized CBs before mapping the remaining tones can correspond to inter-CC frequency interleaving with maximum frequency diversity. In some aspects, when priority information is used for the mapping of tones of the CBs to the REs of the CCs within the aggregated bandwidth, the mapping of the different tones to different CCs is not uniform across CBs. From the rate-matching procedure performed on the UE-side, the inter-CC frequency interleaving with CB prioritization can be a deterministic process where only the block size C is then needed for signaling the inter-CC interleaving configuration.

In some aspects, the block size of the inter-CC frequency interleaver equals the number of CBs to be mapped, and the number of REs in each CC is a multiple of the number of CBs to be mapped by the inter-CC frequency interleaver (e.g., (#REs in the CC) mod C=0). In response, the inter-CC frequency interleaver can be configured to map the tones from each CB to the different CCs within the aggregated bandwidth to provide maximum protection to systematic bits. For example, when the block size equals the number of CBs and the number of REs per CC is an integer multiple of the number of CBs, systematic bits can be mapped to REs within CCs that provide maximum protection, with the inter-CC frequency interleaving implementing the mapping to also spread the tones of each CB across the entire bandwidth of the virtual band or virtual carrier comprising N_{CC} CCs. For example, spreading the tones of each CB across the entire bandwidth of the virtual band or carrier (e.g., the aggregated bandwidth, etc.) can correspond to allocating a portion of the tones within a CB to each different CC included in the bandwidth of the virtual band or carrier.

In one illustrative example, CCs that have a non-uniform number of REs per CC may be allocated and filled at different rates. For example, using equal allocation between the three CCs 1005-1, 1005-2, 1005-N shown in FIG. 10, blocks of tones may initially be allocated equally across the REs of the three CCs. The smallest CC, CC 2 1005-2, becomes full first, and the allocation then continues with allocation of the remaining blocks of tones performed only between the non-filled CCs, CC1 1005-1 and CC-N 1005-N, etc. In some aspects, when a particular CC or SB becomes completely filled with REs, the remaining tones for allocation by the inter-CC interleaver can be sequentially mapped to the remaining resources (e.g., REs) available in the remaining CCs of the aggregated bandwidth that have not yet been filled.

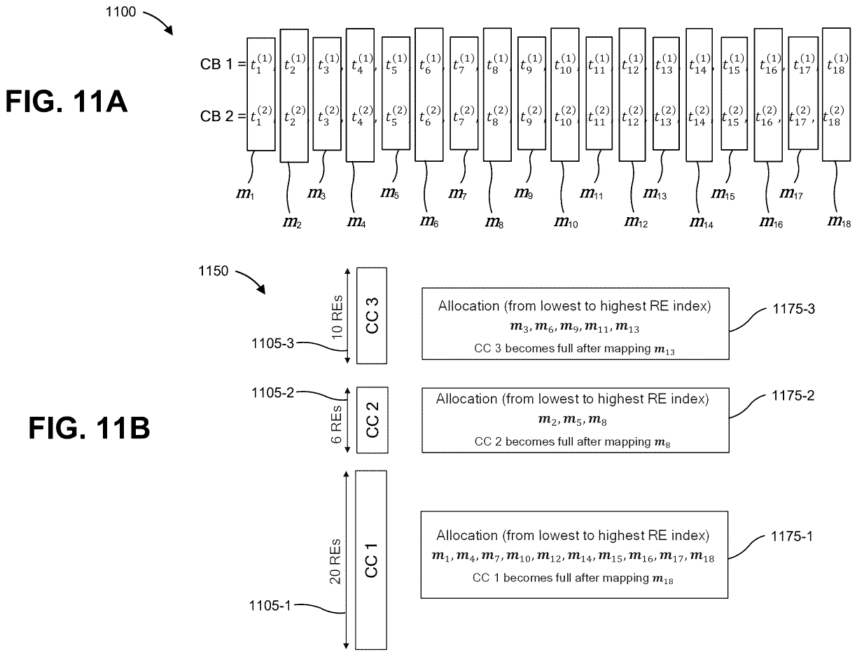

For example, FIG. 11A illustrates an example of a mapping 1100 for a plurality of tones corresponding to a first or second CB included in a set of two CBs for inter-CC frequency interleaving, in accordance with some examples. A first CB, CB 1, and a second CB, CB 2, each correspond to a respective set of tones indexed according to a shared plurality of CB tone indices, wherein the respective set of tones for each CB are divided into blocks of tones according to the tone indices. The notation

$${t}_{i}^{( c )}$$

represents the i^{th} tone of the c^{th} CB. The mapping 1100 of FIG. 11A corresponds to an example where the number of CBs is two (e.g., C=2), and the block size of each block mᵢ determined for the inter-CC frequency interleaving is also equal to 2.

The two CBs, CB 1 and CB 2, include 18 tones each, for a total number of tones equal to 36. The inter-CC frequency interleaving blocks can be determined as the blocks m₁, m₂, . . . , m₁₇, m₁₈ where each block mᵢ includes the respective tone

$${t}_{i}^{( 1 )}$$

having the same index i in the sequence of tones for CB 1, and includes the respective tone

$${t}_{i}^{( 2 )}$$

having the same index i in the sequence of tones for CB 2. In an illustrative example, the blocks mᵢ for the inter-CC frequency interleaving comprise the tones at the same index position within each CB of the set of CBs (e.g., a first block includes the first tone index position from each respective CB of the set of CBs, a second block includes the second tone index position from each respective CB of the set of CBs, . . . , etc.).

In one illustrative example of inter-CC frequency interleaving for CCs of an aggregated bandwidth comprising different numbers of REs per CC, where each CC has a number of REs that is an integer multiple of the number of CCs, the set of CCs can be the three CCs 1105-1, 1105-2, 1105-3 illustrated in the example inter-CC interleaving 1150 of FIG. 11B. The first CC 1 1105-1 includes 20 REs, the second CC 2 1105-2 includes 6 REs, and the third CC 3 1105-3 includes 10 REs. Each of the three CCs has a different number of REs that is an integer multiple of the number of CBs (e.g., the two CBs, CB 1 and CB 2, shown in FIG. 11A).

In some aspects, the two CBs of FIG. 11A include 36 tones that can be mapped across the N_{CC}=3 CCs (e.g., 1105-1, 1105-2, 1105-3) of FIG. 11B that include a total of 36 REs. For example, the inter-CC interleaving procedure can be implemented according to the example algorithm steps below.

One. Assign indexes to each CC to build a CC set Ω={1,2, . . . , N_{CC}}.

Two. Divide REs at the output of the intra-CC frequency interleaver (e.g., intra-CC subblock interleaver 825 of FIG. 8, etc.) into blocks of C tones, where C is the number of CBs to be mapped across the different CCs, to obtain the sequence of blocks of tones m₁, m₂, . . . , mₛ, where mᵢ contains the ith tone of each CB, ordered in increasing CB index. Set the value of a counting parameter s=1.

Three. Map the s^{th} set mₛ to the next available REs in CC Ωᵢ_{ₛ} with index iₛ=mod(s−1, |Ω|)+1.

Four. If CC Ωᵢ_{ₛ} is filled after Step 3, update CC set as Ω=Ω\Ωᵢ_{ₛ}.

Five. Update s=s+1 and continue the algorithm from Step 3 onwards until every RE has been mapped to the different CCs.

For example, at the completion of the inter-CC frequency interleaving, the allocation of blocks of tones from CB 1 and CB 2 of FIG. 11A, to the REs of CC 1 of FIG. 11B, is illustrated as the allocation 1175-1. The allocation 1175-2 maps blocks of tones from CB 1 and CB 2 to the REs of CC 2 of FIG. 11B, and the allocation 1175-3 maps blocks of tones from CB 1 and CB 2 to the REs of CC 3 of FIG. 11B.

To de-interleave the inter-CC frequency interleaved blocks of tones allocated according to the per-CC RE allocations 1175-1, 1175-2, 1175-3 of FIG. 11B, the de-interleaving may be performed based on the example de-interleaving algorithm below.

One. Assign indexes to each CC to build a CC set Ω={0,1, . . . , N_{CC}−1}.

Two. Divide REs from each CC into blocks of C tones, where C is the number of CBs to be mapped across the different CCs, to obtain the different blocks

$${m}_{1}^{( c )} , {m}_{2}^{( c )} , … , {m}_{{M}_{c}}^{( c )} ,$$

where

$${m}_{m}^{( c )}$$

contains the mth block of C tones mapped to CC #c. Set s=0, m=1, z={Ø}.

Three. Update

$$z = [ z , {m}_{m}^{( {i}_{s} )} ] ,$$

where

$${m}_{m}^{( {i}_{s} )}$$

is the mth block of C tones from the CC Ωᵢ_{ₛ} with index iₛ=mod(s, |Ω|).

Four. If the last block in CC Ωᵢ_{ₛ} is read after Step 3, update CC set as Ω=Ω\Ωᵢ_{ₛ}, s=s−1.

Five. If s=|Ω|−1, update m=m+1, s=s+1 and continue the algorithm from Step 3. Else, update s=s+1, and continue the algorithm from Step 3.

The blocks of tones in allocation 1175-1 for CC 1 1105-1 in FIG. 11B corresponds, in the de-interleaving process, to obtaining the blocks

$${m}_{1}^{( 1 )} , {m}_{2}^{( 1 )} , {m}_{3}^{( 1 )} , {m}_{4}^{( 1 )} , … , {m}_{10}^{( 1 )} .$$

The blocks of tones in allocation 1175-2 for CC 2 1105-2 in FIG. 11B corresponds to obtaining during de-interleaving the blocks

$${m}_{1}^{( 2 )} , {m}_{2}^{( 2 )} , {m}_{3}^{( 2 )} \qquad ( 2 )$$

The blocks of tones in allocation 1175-3 for CC 3 1105-3 in FIG. 11B corresponds to obtaining during the de-interleaving process the blocks

$${m}_{1}^{( 3 )} , {m}_{2}^{( 3 )} , {m}_{3}^{( 3 )} , {m}_{4}^{( 3 )} , {m}_{5}^{( 3 )} \qquad ( 3 )$$

In an illustrative example, the de-interleaving (e.g., reading) of the blocks across CCs 1105-1, 1105-2, 1105-3 results in obtaining the blocks:

$${m}_{1}^{( 1 )} , {m}_{1}^{( 2 )} , {m}_{1}^{( 3 )} , {m}_{2}^{( 1 )} , {m}_{2}^{( 2 )} , {m}_{2}^{( 3 )} , {m}_{3}^{( 1 )} , {m}_{3}^{( 2 )} , {m}_{3}^{( 3 )} , \\ {m}_{4}^{( 1 )} , {m}_{4}^{( 3 )} , {m}_{5}^{( 1 )} , {m}_{5}^{( 3 )} , {m}_{6}^{( 1 )} , {m}_{7}^{( 1 )} , {m}_{8}^{( 1 )} , {m}_{9}^{( 1 )} , {m}_{10}^{( 1 )}$$

In another illustrative example, when the number of REs in one or more, or all, of the CCs of the aggregated bandwidth is not a multiple of the number of CBs being mapped by the inter-CC interleaver, the network entity may be configured to perform rate-matching on a number of REs for each CC, where the REs for rate matching are selected as a subset of the total REs of each CC such that the subset of REs is an integer multiple of the number of CBs. The subset of REs used for rate matching for each CC can be the total number of REs in the CC minus (#REs in CC) mod C (e.g., the total number of REs in the CC minus the remainder portion of REs when dividing the total number of REs by the number of CBs. In some aspects, the remainder portion of REs that are included in a CC, beyond the integer multiple of the number of CBs, are not used by the inter-CC frequency interleaver, which performs the frequency interleaving over only the respective integer multiple portion of REs in each CC (e.g., the remainder REs are ignored, left unused, etc., and the inter-CC frequency interleaving is performed as above following the algorithm for CCs that a number of REs equal to an integer multiple of the number of CBs).

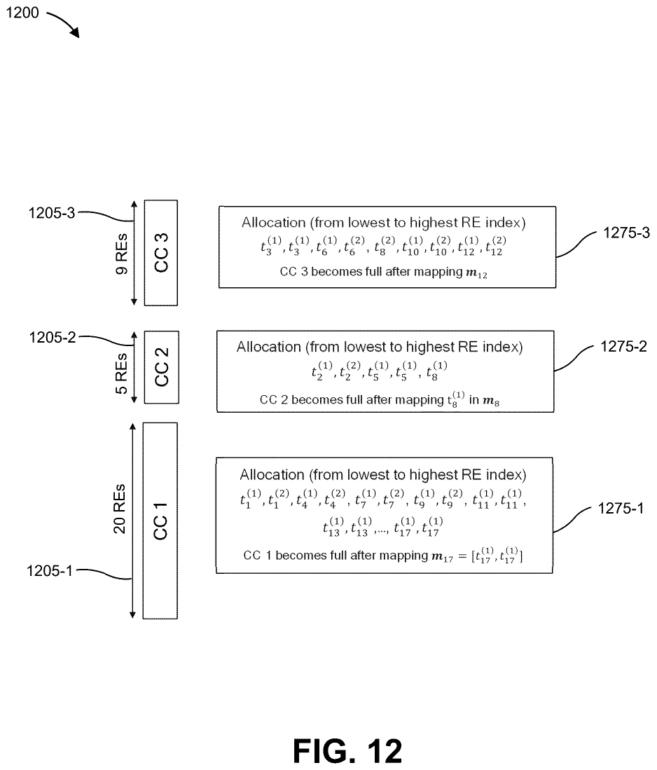

FIG. 12 illustrates an example of inter-CC frequency interleaving 1200 of a plurality of tones corresponding to first and second CBs across respective CCs of a plurality of CCs corresponding to an aggregated bandwidth and including a number of REs that is not an integer multiple of the number of CBs, in accordance with some examples. In some cases, CC 1 1205-1 of FIG. 12 includes 20 REs and can be the same as or similar to CC 1 1105-1 of FIG. 11B. CC 2 1205-2 of FIG. 12 includes 5 REs, which corresponds to a remainder of 5 mod 2=1 RE for the mapping of the two CBs, CB 1 and CB 2, of FIG. 11A. CC 3 1205-3 of FIG. 12 includes 9 REs, which corresponds to a remainder of 9 mod 2=1 RE for the mapping of the two CBs, CB 1 and CB 2, of FIG. 11A.

In some aspects, the network entity can configure the inter-CC frequency interleaver to perform rate matching on every RE included in each CC, including any REs of the remainder portion beyond the integer multiple of CBs portion of REs in a CC. Rate matching for every RE in each CC can correspond to operating the inter-CC frequency interleaver at the level of RE per CB, instead of the level of a group of REs including respective tones for every CB. An example inter-CC frequency interleaving algorithm is described below for the example where the set of CCs in the aggregated bandwidth include respective numbers of REs that are not multiples of the number of CBs.

One, Two. Perform Steps 1 and 2 as in the example interleaving algorithm above to obtain the sequence m₁, m₂, . . . , mₛ, where m₁ contains the ith tone of each CB, ordered in increasing CB index, as

$${m}_{i} = [ {t}_{1}^{( i )} , {t}_{2}^{( i )} , … , {t}_{C}^{( i )} ] ,$$

where

$${t}_{c}^{( i )}$$

denotes the ith tone of the cth CB. Set the value of a counting parameter s=0.

Three. Compute the CC index to map mₛ as iₛ=mod(s, |Ω|)+1. If the number of available REs in CC Ωᵢ_{ₛ} is larger than or equal to the block size C, map mₛ to the next available REs in CC Ωᵢ_{ₛ}. Else, if the number of available REs in CC Ωᵢ_{ₛ} is n_{RE,orphan}, map the first n_{RE,orphan} REs in

$${m}_{s} , {t}_{1}^{( i )} , {t}_{2}^{( i )} , … , {t}_{{n}_{RE , orphan}}^{( i )} ,$$

to CC Ωᵢ_{ₛ}; Update Ω=Ω\Ωᵢ_{ₛ}; and Map the remaining C−n_{RE,orphan} REs,

$${t}_{{n}_{RE , orphan} + 1}^{( i )} , … , {t}_{C}^{( i )}$$

to the next available REs in CC Ωᵢ_{ₛ}, with iₛ=mod(s, |Ω|)+1, repeating the process from Step 3 until every RE in mₛ is mapped.

Four. If CC Ωᵢ_{ₛ} is filled after Step 3, update CC set as Ω=Ω\Ωᵢ_{ₛ}, s=s−1.

Five. Update s=s+1 and continue the algorithm from 3 onwards until every RE has been mapped to the different CCs.

After inter-CC frequency interleaving according to the example interleaving algorithm above, the allocation 1275-1 of tones to REs of the first CC 1 1205-1 comprises

$${t}_{1}^{( 1 )} , {t}_{1}^{( 2 )} , {t}_{4}^{( 1 )} , {t}_{4}^{( 2 )} , {t}_{7}^{( 1 )} , {t}_{7}^{( 2 )} , {t}_{9}^{( 1 )} , {t}_{9}^{( 2 )} , {t}_{11}^{( 1 )} , {t}_{11}^{( 1 )} , {t}_{13}^{( 1 )} , {t}_{13}^{( 1 )} , … , {t}_{17}^{( 1 )} , {t}_{17}^{( 1 )}$$

and the REs of CC 1 1205-1 are filled after mapping

$${m}_{17} = [ {t}_{17}^{( 1 )} , {t}_{17}^{( 1 )} ] .$$

The allocation 1275-2 of tones to REs of the second CC 2 1205-2 comprises

$${t}_{2}^{( 1 )} , {t}_{2}^{( 2 )} , {t}_{5}^{( 1 )} , {t}_{5}^{{( 1 )}_{1}} {t}_{8}^{( 1 )}$$

and CC 2 1205-2 becomes full after mapping

$${t}_{8}^{( 1 )}$$

in m₈. The allocation 1275-3 of tones to REs of the third CC 1205-3 comprises

$${t}_{3}^{( 1 )} , {t}_{3}^{( 1 )} , {t}_{6}^{( 1 )} , {t}_{6}^{( 2 )} , {t}_{8}^{( 2 )} , {t}_{10}^{( 1 )} , {t}_{10}^{( 2 )} , {t}_{12}^{( 1 )} , {t}_{12}^{( 2 )}$$

and CC 3 1205-3 becomes full after mapping m₁₂.

In some aspects, after a CC is filled according to the interleaving algorithm above, the separation in frequency between consecutive tones of a CC may decrease, for example based on the amount of available REs differing for the different CCs. In some examples, after mapping the remaining tones of a given mₛ in Ωᵢ_{ₛ} as above, the tones in mₛ₊₁ may be mapped in the same CC as the last tones in mₛ or may be mapped in the next CC following the update.

A corresponding example de-interleaving algorithm to de-interleave the inter-CC frequency interleaving applied for the example of FIG. 12 is below.

One, Two. Denote the tones belonging to CC #c as

$${t}_{1}^{( c )} , {t}_{2}^{( c )} , … , {t}_{{N}_{R E}^{( c )}}^{( c )} ,$$

where

$${t}_{ℓ}^{( c )}$$

denotes the [symbol] th tone in the cth CC. Set s=0, z={Ø}, Ω={0,1, . . . N_{CC}−1}.

Three. Compute the CC index from which to read the next C tones, represented by the 1×C vector

$${m}_{m}^{( {i}_{s} )}$$

as iₛ=mod(s, |Ω|). If the number of remaining unread REs in CC Ωᵢ_{ₛ} is greater than or equal to the block size C, update

$$z = [ z , {m}_{m}^{( {i}_{s} )} ] .$$

Else, if the number of available REs in CC Ωᵢ_{ₛ} is n_{RE,orphan}, denote the last n_{RE,orphan} tones in CC Ωᵢ_{ₛ} by

$${m}_{m , orphan}^{( {i}_{s} )}$$

and update

$$z = [ z , {m}_{m , orphan}^{( {i}_{s} )} ] ;$$

Update Ω=Ω\Ωᵢ_{ₛ}; and Read the next C−n_{RE,orphan} unread tones in CC Ωᵢ_{ₛ}, denoted by

$${m}_{m , orphan , rem}^{( {i}_{s} )} ,$$

and update

$$z = [ z , {m}_{m , orphan , rem}^{( {i}_{s} )} ] ,$$

with iₛ=mod(s, |Ω|).

Four. If the last tone in CC Ωᵢ_{ₛ} has been read after Step 3, update CC set as Ω=Ω\Ωᵢ_{ₛ}, s=s−1.

Five. Update s=s+1 and continue the algorithm from 3 onwards until every RE has been read from the different CCs.

The result of the de-interleaving (e.g., reading) of tones across the CCs is

$${t}_{1}^{( 1 )} , {t}_{2}^{( 1 )} , {t}_{1}^{( 2 )} , {t}_{2}^{( 2 )} , {t}_{1}^{( 3 )} , {t}_{2}^{( 3 )} , {t}_{3}^{( 1 )} , {t}_{4}^{( 1 )} , {t}_{3}^{( 2 )} , {t}_{4}^{( 2 )} , {t}_{3}^{( 3 )} , {t}_{4}^{( 3 )} , {t}_{5}^{( 1 )} , {t}_{6}^{( 1 )} , {t}_{5}^{( 2 )} , {t}_{5}^{( 3 )} , {t}_{7}^{( 1 )} , {t}_{8}^{( 1 )} , {t}_{6}^{( 3 )} , {t}_{7}^{( 3 )} , {t}_{9}^{( 1 )} , {t}_{10}^{( 1 )} , {t}_{8}^{( 3 )} , {t}_{9}^{( 3 )} , {t}_{11}^{( 1 )} , {t}_{12}^{( 1 )} , … , {t}_{20}^{( 1 )} .$$

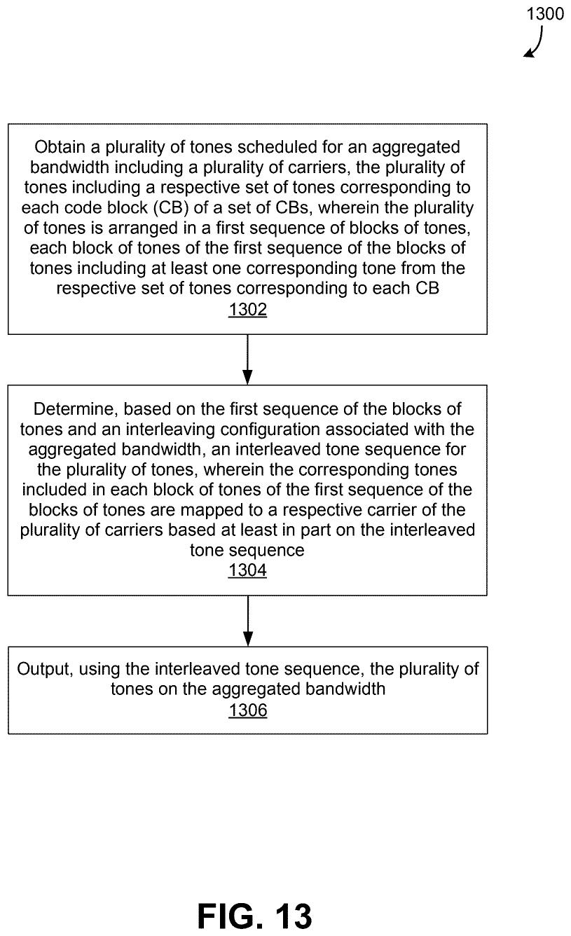

FIG. 13 is a flowchart diagram illustrating an example of a process 1300 for wireless communication. The process 1300 may be performed by an apparatus for wireless communication at a device or a component (e.g., a chipset, codec, etc.) of the apparatus or device. The apparatus and/or device may be a UE (e.g., the UE 104 of FIG. 1, FIG. 2, and/or FIG. 3, the wireless device 407 of FIG. 4, or other UE). The apparatus and/or device may be a network entity (e.g., base station). In some examples, the process 1300 may be performed by a network entity or network device (or apparatus) or a component (e.g., a chipset, codec, etc.) of the network entity or device. For example, the apparatus and/or device may be a network entity such as a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3), server device, or other network entity. In some examples, the apparatus and/or device (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 1300 may be implemented as software components that are executed and run on one or more processors (e.g., one or more of the communication manager 140, the communication manager 150, the transmit processor 264, the receive processor 258, the TX MIMO processor 266, the MIMO detector 256 of FIG. 2, the processing system 470 of FIG. 4, the processor(s) 484 of FIG. 4, the processing system 1502 of FIG. 15, and/or the processor 1510 of FIG. 15, or other processor(s) (e.g., such as one or more other processors included within and/or associated with the processing system 470 of FIG. 4, the processing system 1502 of FIG. 15, etc.)). Further, the transmission and reception of signals by the apparatus and/or device in the process 1300 may be enabled, for example, by one or more antennas, one or more transceivers (e.g., wireless transceiver(s)), and/or other communication components (e.g., one or more of the communication manager 140, the communication manager 140, the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 1540 of FIG. 15, or other antennae(s), transceiver(s), and/or component(s)).

At block 1302, the apparatus (or component thereof) can cause the device to obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB.

For example, a network entity (e.g., using communication manager 150) may obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB.

In some examples, a UE (e.g., using communication manager 140) may obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB.

At block 1304, the apparatus (or component thereof) can cause the device to determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence.

For example, a network entity (e.g., using communication manager 150) may determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence.

In some examples, a UE (e.g., using communication manager 140) may determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence.

At block 1306, the apparatus (or component thereof) can cause the device to output, using the interleaved tone sequence, the plurality of tones on the aggregated bandwidth. For example, a network entity (e.g., using communication manager 150) may output, using the interleaved tone sequence, the plurality of tones on the aggregated bandwidth. In some examples, a UE (e.g., using communication manager 140) may output, using the interleaved tone sequence, the plurality of tones on the aggregated bandwidth.

In a first aspect, each block of tones of the first sequence of the blocks of tones comprises a respective subset of tones included in the plurality of tones; and a number of tones in the respective subset of tones is equal to a number of CBs of the set of CBs.

In a second aspect, alone or in combination with the first aspect, a plurality of tone index values is mapped to the respective set of tones corresponding to each CB of the set of CBs; and each block of tones of the first sequence of the blocks of tones corresponds to a particular tone index value of the plurality of tone index values.

In a third aspect, alone or in combination with one or more of the first and second aspects, each block of tones of the first sequence of the blocks of tones comprises a respective subset of tones included in the plurality of tones, and wherein each tone of the respective subset of tones is mapped to the particular tone index value within the respective set of tones for a different CB of the set of CBs.

In a fourth aspect, alone or in combination with one or more of the first through third aspects, one or more tones from each respective set of tones are mapped to one or more corresponding resource elements (REs) associated with each carrier of the plurality of carriers based at least in part on the interleaved tone sequence.

In a fifth aspect, alone or in combination with one or more of the first through fourth aspects, consecutive tones within the respective set of tones corresponding to each CB are mapped to different carriers of the plurality of carriers based on the interleaved tone sequence; and each pair of consecutive tones of a plurality of pairs of consecutive tones within the respective set of tones corresponding to each CB are separated in frequency by a threshold number of resource elements (REs).

In a sixth aspect, alone or in combination with one or more of the preceding aspects, consecutive tones within the respective set of tones corresponding to each CB are mapped to different carriers of the plurality of carriers based on the interleaved tone sequence.

In a seventh aspect, alone or in combination with one or more of the preceding aspects, each pair of consecutive tones of a plurality of pairs of consecutive tones within the respective set of tones corresponding to each CB are separated in frequency by a threshold number of resource elements (REs).

In an eighth aspect, alone or in combination with one or more of the preceding aspects, the threshold number of REs is the same for each pair of consecutive tones of the plurality of pairs of consecutive tones.

In a ninth aspect, alone or in combination with one or more of the preceding aspects, the interleaving configuration includes an indication of an interleaving size and an interleaving depth corresponding to the interleaved tone sequence.

In a tenth aspect, alone or in combination with one or more of the preceding aspects, each block of tones of the first sequence of the blocks of tones includes a number of respective tones of the plurality of tones equal to a number of CBs of the set of CBs.

In an eleventh aspect, alone or in combination with one or more of the preceding aspects, the one or more processors are configured to cause the device to: transmit information indicative of the interleaving configuration, wherein the information is included in control information corresponding to at least one of a Multimedia Broadcast Multicast Service (MBMS) associated with the apparatus, or a Multicast-Broadcast Single Frequency Network (MBSFN) Area associated with the apparatus.

In a twelfth aspect, alone or in combination with one or more of the preceding aspects, the one or more processors are configured to cause the device to: transmit information indicative of the interleaving configuration, wherein the information is included in control information corresponding to a Multimedia Broadcast Multicast Service (MBMS) associated with the apparatus.

In a thirteenth aspect, alone or in combination with one or more of the preceding aspects, the one or more processors are configured to cause the device to: transmit information indicative of the interleaving configuration, wherein the information is included in control information corresponding to a Multicast-Broadcast Single Frequency Network (MBSFN) Area associated with the apparatus.

In a fourteenth aspect, alone or in combination with one or more of the preceding aspects, the one or more processors are configured to cause the device to: transmit a multicast control channel (MCCH) message including information indicative of the interleaving configuration.

In a fifteenth aspect, alone or in combination with one or more of the preceding aspects, the information indicative of the interleaving configuration is included in a Multicast-Broadcast Single Frequency Network (MBSFN) Area information element (IE) of the MCCH message.

In a sixteenth aspect, alone or in combination with one or more of the preceding aspects, the one or more processors are configured to cause the device to: transmit information indicative of the interleaving configuration, wherein the information is included in a Multicast-Broadcast Single Frequency Network (MBSFN) Area information element (IE).

In a seventeenth aspect, alone or in combination with one or more of the preceding aspects, the one or more processors are configured to cause the device to: transmit a Multicast Channel (MCH) Scheduling Information (MSI) Media Access Control (MAC) Control Element (MAC-CE), wherein the MSI MAC-CE includes information indicative of the interleaving configuration.

In an eighteenth aspect, alone or in combination with one or more of the preceding aspects, the one or more processors are configured to cause the device to: transmit first signaling including an indication to enable frequency interleaving of the plurality of tones of the set of CBs across the plurality of carriers; and transmit second signaling indicative of one or more parameters for the interleaving configuration, wherein the one or more parameters include one or more of an interleaving size or an interleaving depth.

In a nineteenth aspect, alone or in combination with one or more of the preceding aspects, the one or more processors are configured to cause the device to: transmit first signaling including an indication to enable frequency interleaving of the plurality of tones of the set of CBs across the plurality of carriers.

In a twentieth aspect, alone or in combination with one or more of the preceding aspects, the one or more processors are configured to cause the device to: transmit second signaling indicative of one or more parameters for the interleaving configuration, wherein the one or more parameters include one or more of an interleaving size or an interleaving depth.

In a twenty-first aspect, alone or in combination with one or more of the preceding aspects, to transmit the second signaling, the one or more processors are configured to cause the device to: transmit a Multicast Channel (MCH) Scheduling Information (MSI) message, wherein the MSI message includes configured values for the interleaving size and the interleaving depth.

In a twenty-second aspect, alone or in combination with one or more of the preceding aspects, the one or more processors are configured to cause the device to: transmit information indicative of the interleaving configuration, wherein the information comprises an index value corresponding to a particular configuration of one or more parameters to determine the interleaved tone sequence, and wherein the index value is included in a plurality of configured index values corresponding to a plurality of configurations of the one or more parameters.

In a twenty-third aspect, alone or in combination with one or more of the preceding aspects, the one or more processors are configured to cause the device to: transmit information indicative of the interleaving configuration, wherein the information comprises an index value corresponding to a particular configuration of one or more parameters to determine the interleaved tone sequence,

In a twenty-fourth aspect, alone or in combination with one or more of the preceding aspects, the index value is included in a plurality of configured index values corresponding to a plurality of configurations of the one or more parameters.

In a twenty-fifth aspect, alone or in combination with one or more of the preceding aspects, the one or more processors are configured to cause the device to: transmit information indicative of the interleaving configuration, wherein the information is transmitted using at least one of: a group-common downlink control information (GC-DCI), or a group-common physical downlink control channel (GC-PDCCH) including cross-carrier scheduling information associated with the plurality of carriers and indicative of the information.

In a twenty-sixth aspect, alone or in combination with one or more of the preceding aspects, the one or more processors are configured to cause the device to: transmit information indicative of the interleaving configuration, wherein the information is transmitted using a group-common downlink control information (GC-DCI)

In a twenty-seventh aspect, alone or in combination with one or more of the preceding aspects, the one or more processors are configured to cause the device to: transmit information indicative of the interleaving configuration, wherein the information is transmitted using a group-common physical downlink control channel (GC-PDCCH) including cross-carrier scheduling information associated with the plurality of carriers and indicative of the information.

In a twenty-eighth aspect, alone or in combination with one or more of the preceding aspects, the one or more processors are configured to cause the device to transmit signaling indicative of block size information for the first sequence of blocks of tones, wherein the block size information corresponds to a number of tones included in each block of the first sequence of blocks; and the signaling includes radio resource control (RRC) signaling, media access control (MAC)-control element (MAC-CE) signaling, or downlink control information (DCI) signaling.

In a twenty-ninth aspect, alone or in combination with one or more of the preceding aspects, the one or more processors are configured to cause the device to transmit signaling indicative of block size information for the first sequence of blocks of tones, wherein the block size information corresponds to a number of tones included in each block of the first sequence of blocks.

In a thirtieth aspect, alone or in combination with one or more of the preceding aspects, the signaling includes radio resource control (RRC) signaling, media access control (MAC)-control element (MAC-CE) signaling, or downlink control information (DCI) signaling.

In a thirty-first aspect, alone or in combination with one or more of the preceding aspects, to determine the interleaved tone sequence, the one or more processors are configured to cause the device to: determine one or more prioritized blocks of tones of the first sequence of the blocks of tones, wherein the one or more prioritized blocks of tones include respective tones corresponding to prioritized CBs of the set of CBs; map the corresponding tones included in each of the one or more prioritized blocks of tones to respective carriers of the plurality of carriers; and map the corresponding tones included in a remaining set of blocks of tones of the first sequence of the blocks of tones to respective carriers of the plurality of carriers, wherein the remaining set of blocks of tones are mapped after the prioritized blocks of tones are mapped.

In a thirty-second aspect, alone or in combination with one or more of the preceding aspects, to determine the interleaved tone sequence, the one or more processors are configured to cause the device to: determine one or more prioritized blocks of tones of the first sequence of the blocks of tones, wherein the one or more prioritized blocks of tones include respective tones corresponding to prioritized CBs of the set of CBs.

In a thirty-third aspect, alone or in combination with one or more of the preceding aspects, to determine the interleaved tone sequence, the one or more processors are configured to cause the device to: map the corresponding tones included in each of the one or more prioritized blocks of tones to respective carriers of the plurality of carriers.

In a thirty-fourth aspect, alone or in combination with one or more of the preceding aspects, to determine the interleaved tone sequence, the one or more processors are configured to cause the device to: map the corresponding tones included in a remaining set of blocks of tones of the first sequence of the blocks of tones to respective carriers of the plurality of carriers, wherein the remaining set of blocks of tones are mapped after the prioritized blocks of tones are mapped.

In a thirty-fifth aspect, alone or in combination with one or more of the preceding aspects, a number of resource elements (REs) corresponding to each carrier of the plurality of carriers is the same.

In a thirty-sixth aspect, alone or in combination with one or more of the preceding aspects, the number of REs corresponding to each carrier of the plurality of carriers is a multiple of a number of CBs in the set of CBs.

In a thirty-seventh aspect, alone or in combination with one or more of the preceding aspects, to determine the interleaved tone sequence, the one or more processors are configured to cause the device to map each respective block of tones of the first sequence of the blocks of tones to a respective carrier determined from a set of available carriers; each respective block of tones is mapped using a mapping order corresponding to an order of each respective block of tones in the first sequence; and the set of available carriers comprises one or more carriers of the plurality of carriers with a respective quantity of available REs greater than or equal to a quantity of tones in each respective block of tones.

In a thirty-eighth aspect, alone or in combination with one or more of the preceding aspects, to determine the interleaved tone sequence, the one or more processors are configured to cause the device to map each respective block of tones of the first sequence of the blocks of tones to a respective carrier determined from a set of available carriers.

In a thirty-ninth aspect, alone or in combination with one or more of the preceding aspects, each respective block of tones is mapped using a mapping order corresponding to an order of each respective block of tones in the first sequence.

In a fortieth aspect, alone or in combination with one or more of the preceding aspects, the set of available carriers comprises one or more carriers of the plurality of carriers with a respective quantity of available REs greater than or equal to a quantity of tones in each respective block of tones.

In a forty-first aspect, alone or in combination with one or more of the preceding aspects, wherein the number of REs corresponding to each carrier of the plurality of carriers is equal to a multiple of a number of CBs in the set of CBs plus a remainder, wherein the remainder is less than the number of CBs.

In a forty-second aspect, alone or in combination with one or more of the preceding aspects, to determine the interleaved tone sequence, the one or more processors are configured cause the device to perform rate matching for the number of REs corresponding to each carrier of the plurality of carriers; and the interleaved tone sequence is determined based on using a subset of REs corresponding to each carrier equal to the multiple of the number of CBs.

In a forty-third aspect, alone or in combination with one or more of the preceding aspects, to determine the interleaved tone sequence, the one or more processors are configured cause the device to perform rate matching for the number of REs corresponding to each carrier of the plurality of carriers.

In a forty-fourth aspect, alone or in combination with one or more of the preceding aspects, the interleaved tone sequence is determined based on using a subset of REs corresponding to each carrier equal to the multiple of the number of CBs.

In a forty-fifth aspect, alone or in combination with one or more of the preceding aspects, each carrier of the plurality of carriers includes a first quantity of REs equal to the multiple of the number of CBs, and includes a second quantity of REs equal to the remainder; and the one or more processors are configured to cause the device to determine the interleaved tone sequence without using the second quantity of REs included in each carrier of the plurality of carriers.

In a forty-sixth aspect, alone or in combination with one or more of the preceding aspects, the plurality of carriers comprises a plurality of component carriers associated with carrier aggregation by the apparatus.

In a forty-seventh aspect, alone or in combination with one or more of the preceding aspects, at least a subset of component carriers of the plurality of component carriers are non-contiguous in frequency.

In a forty-eighth aspect, alone or in combination with one or more of the preceding aspects, the aggregated bandwidth is associated with carrier aggregation by the apparatus using at least one of a broadcast configuration or a multicast configuration.

In a forty-ninth aspect, alone or in combination with one or more of the preceding aspects, to output the plurality of tones, the one or more processors are configured to cause the device to: perform allocation of the plurality of tones across respective resource elements (REs) for the plurality of carriers based on the interleaved tone sequence; and broadcast or multicast the plurality of tones according to the allocation.

In a fiftieth aspect, alone or in combination with one or more of the preceding aspects, the first sequence is a first interleaved sequence for the plurality of tones and corresponds to a sub-block interleaver of the apparatus.

In a fifty-first aspect, alone or in combination with one or more of the preceding aspects, to obtain the plurality of tones, the one or more processors are configured to cause the device to obtain the plurality of tones arranged in the first sequence from a sub-block frequency interleaver.

In a fifty-second aspect, alone or in combination with one or more of the preceding aspects, the plurality of tones are output as a downlink transmission corresponding to the aggregated bandwidth.

In a fifty-third aspect, alone or in combination with one or more of the preceding aspects, the device is a network entity, and wherein the one or more processors are configured to cause the device to: transmit information indicative of the interleaving configuration associated with the aggregated bandwidth.

In a fifty-fourth aspect, alone or in combination with one or more of the preceding aspects, the one or more processors are configured to cause the device to transmit the information to one or more user equipments (UEs); and to output the plurality of tones, the one or more processors are configured to cause the device to transmit, to the one or more UEs, the plurality of tones on the aggregated bandwidth, wherein the plurality of tones are transmitted using the interleaved tone sequence.

In a fifty-fifth aspect, alone or in combination with one or more of the preceding aspects, the plurality of tones are output as an uplink transmission corresponding to the aggregated bandwidth.

In a fifty-sixth aspect, alone or in combination with one or more of the preceding aspects, the one or more processors are configured to cause the device to: obtain information indicative of the interleaving configuration associated with the aggregated bandwidth.

In a fifty-seventh aspect, alone or in combination with one or more of the preceding aspects, to obtain the information, the one or more processors are configured to cause the device to receive the information from a network entity; and to output the plurality of tones, the one or more processors are configured to cause the device to transmit, to the network entity, the plurality of tones using the interleaved tone sequence on the aggregated bandwidth.

In a fifty-eighth aspect, alone or in combination with one or more of the preceding aspects, the device is a user equipment (UE).

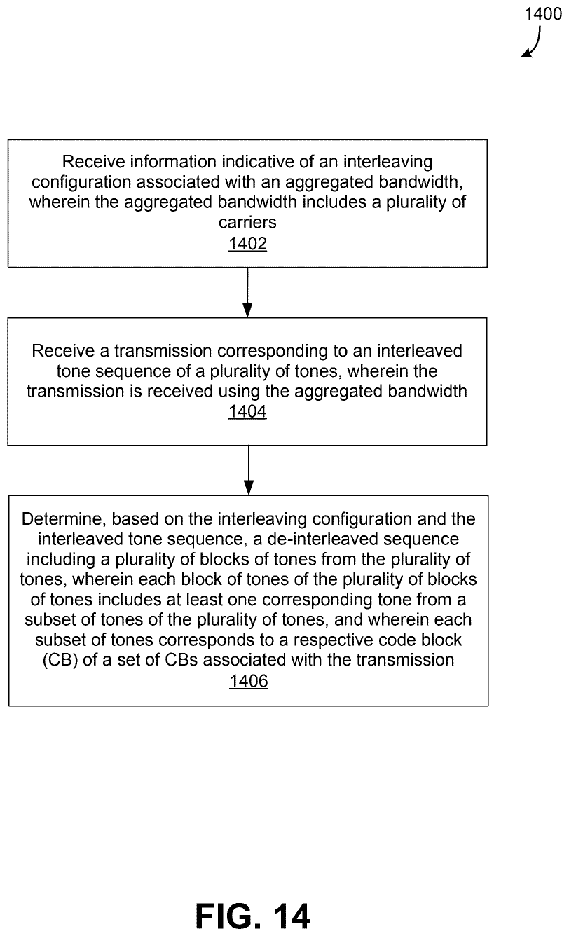

FIG. 14 is a flowchart diagram illustrating an example of a process 1400 for wireless communication. The process 1400 may be performed by a network entity or network device (or apparatus) or a component (e.g., a chipset, codec, etc.) of the network entity or device. The process 1400 may be performed by an apparatus for wireless communication at a user equipment (UE). The process 1400 may be performed by a device or a component (e.g., a chipset, codec, etc.) of the apparatus or device. The apparatus and/or device may be a UE (e.g., the UE 104 of FIG. 1, FIG. 2, and/or FIG. 3, the wireless device 407 of FIG. 4, or other UE). In some examples, the apparatus and/or device (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 1300 may be implemented as software components that are executed and run on one or more processors (e.g., one or more of the communication manager 140, the communication manager 150, the transmit processor 264, the receive processor 258, the TX MIMO processor 266, the MIMO detector 256 of FIG. 2, the processing system 470 of FIG. 4, the processor(s) 484 of FIG. 4, the processing system 1502 of FIG. 15, and/or the processor 1510 of FIG. 15, or other processor(s) (e.g., such as one or more other processors included within and/or associated with the processing system 470 of FIG. 4, the processing system 1502 of FIG. 15, etc.)). Further, the transmission and reception of signals by the apparatus and/or device in the process 1300 may be enabled, for example, by one or more antennas, one or more transceivers (e.g., wireless transceiver(s)), and/or other communication components (e.g., one or more of the communication manager 140, the communication manager 150, the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 1540 of FIG. 15, or other antennae(s), transceiver(s), and/or component(s)).

At block 1402, the apparatus (or component thereof) can cause the device to receive information indicative of an interleaving configuration associated with an aggregated bandwidth, wherein the aggregated bandwidth includes a plurality of carriers. For example, a UE may (e.g., using the communication manager 140) receive information indicative of an interleaving configuration associated with an aggregated bandwidth, wherein the aggregated bandwidth includes a plurality of carriers.

At block 1404, the apparatus (or component thereof) can cause the device to receive a transmission corresponding to an interleaved tone sequence of a plurality of tones, wherein the transmission is received using the aggregated bandwidth. For example, a UE may (e.g., using the communication manager 140) receive a transmission corresponding to an interleaved tone sequence of a plurality of tones, wherein the transmission is received using the aggregated bandwidth.

At block 1406, the apparatus (or component thereof) can cause the device to determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

For example, a UE may (e.g., using the communication manager 140) determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

In a first aspect, the one or more processors are configured to cause the UE to receive the information indicative of the interleaving configuration from a network entity associated with at least one of the transmission or the interleaved tone sequence.

In a second aspect, alone or in combination with the first aspect, the one or more processors are configured to cause the UE to receive the transmission from the network entity.

In a third aspect, alone or in combination with one or more of the first and second aspects, a number of tones in the subset of tones is equal to a number of the plurality of carriers.

In a fourth aspect, alone or in combination with one or more of the first through third aspects, the interleaving configuration is indicative of an interleaving size and an interleaving depth corresponding to the interleaved tone sequence.

In a fifth aspect, alone or in combination with one or more of the first through fourth aspects, each block of tones of the plurality of blocks of tones includes a number of respective tones of the plurality of tones equal to a number of CBs of the set of CBs.

In a sixth aspect, alone or in combination with one or more of the preceding aspects, to receive the information indicative of the interleaving configuration, the one or more processors are configured to cause the UE to: receive control information corresponding to at least one of a Multimedia Broadcast Multicast Service (MBMS) or a Multicast-Broadcast Single Frequency Network (MBSFN) Area.

In a seventh aspect, alone or in combination with one or more of the preceding aspects, to receive the information indicative of the interleaving configuration, the one or more processors are configured to cause the UE to: receive a multicast control channel (MCCH) message including the information.

In an eighth aspect, alone or in combination with one or more of the preceding aspects, the information indicative of the interleaving configuration is included in a Multicast-Broadcast Single Frequency Network (MBSFN) Area information element (IE) of the MCCH message.

In a ninth aspect, alone or in combination with one or more of the preceding aspects, to receive the information indicative of the interleaving configuration, the one or more processors are configured to cause the UE to: receive a Multicast Channel (MCH) Scheduling Information (MSI) Media Access Control (MAC) Control Element (MAC-CE), wherein the MSI MAC-CE includes the information.

In a tenth aspect, alone or in combination with one or more of the preceding aspects, the one or more processors are configured to cause the UE to: receive first signaling including an indication to enable frequency interleaving of the plurality of tones of the set of CBs across the plurality of carriers; and receive second signaling indicative of one or more parameters for the interleaving configuration, wherein the one or more parameters include one or more of an interleaving size or an interleaving depth.

In an eleventh aspect, alone or in combination with one or more of the preceding aspects, to receive the second signaling, the one or more processors are configured to cause the UE to: receive a Multicast Channel (MCH) Scheduling Information (MSI) message, wherein the MSI message includes configured values for the interleaving size and the interleaving depth.

In a twelfth aspect, alone or in combination with one or more of the preceding aspects, the information indicative of the interleaving configuration includes an index value corresponding to a particular configuration of one or more parameters used to determine the interleaved tone sequence, and wherein the index value is included in a plurality of configured index values corresponding to a plurality of configurations of the one or more parameters.

In a thirteenth aspect, alone or in combination with one or more of the preceding aspects, the information indicative of the interleaving configuration is included in at least one of: group-common downlink control information (GC-DCI) or a group-common physical downlink control channel (GC-PDCCH) including cross-carrier scheduling information associated with the plurality of carriers and indicative of the information.

In a fourteenth aspect, alone or in combination with one or more of the preceding aspects, the one or more processors are configured to cause the UE to: receive signaling indicative of block size information associated with the interleaved tone sequence, wherein the block size information corresponds to a number of tones included in each block of tones of the plurality of blocks of tones; and determine the de-interleaved sequence using the block size information.

In a fifteenth aspect, alone or in combination with one or more of the preceding aspects, the signaling indicative of block size information includes radio resource control (RRC) signaling, media access control (MAC)-control element (MAC-CE) signaling, or downlink control information (DCI) signaling.

In a sixteenth aspect, alone or in combination with one or more of the preceding aspects, the transmission corresponding to an interleaved tone sequence is a broadcast or a multicast by a network entity, and wherein the one or more processors are configured to cause the UE to receive the information indicative of the interleaving configuration from the network entity.

In some cases, the computing device or apparatus configured to perform the process 1300 and/or the process 1400 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, 6G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1300 and the process 1400 are illustrated as logical flow diagrams, the operations of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1300 and/or the process 1400 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500 including a processing system 1502, which may be for example any computing device making up internal computing system, a remote computing system, a camera, or any component thereof in which the components of the system are in communication with each other using connection 1505. Connection 1505 may be a physical connection using a bus, or a direct connection into processor 1510 (and/or one or more other processors included within and/or associated with the processing system 1502), such as in a chipset architecture. Connection 1505 may also be a virtual connection, networked connection, or logical connection.

In some aspects, computing system 1500 and/or the processing system 1502 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 1502 includes at least one processing unit (CPU or processor) 1510 and connection 1505 that communicatively couples various system components including system memory 1515, such as read-only memory (ROM) 1520 and random access memory (RAM) 1525 to processor 1510. The processing system 1502 may include a cache 1512 of high-speed memory connected directly with, in close proximity to, or integrated as part of processor 1510 and/or one or more other processors included within and/or associated with the processing system 1502.

Processor 1510 may include any general-purpose processor and a hardware service or software service, such as services 1532, 1534, and 1536 stored in storage device 1530, configured to control processor 1510 and/or one or more other processors included within and/or associated with the processing system 1502, as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, processing system 1502 includes an input device 1545, which may represent any number of input mechanisms, such as a microphone for speech, a touch-sensitive screen for gesture or graphical input, keyboard, mouse, motion input, speech, etc. Processing system 1502 may also include output device 1535, which may be one or more of a number of output mechanisms. In some instances, multimodal systems may enable a user to provide multiple types of input/output to communicate with processing system 1502.

Processing system 1502 may include communications interface 1540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 may include software services, servers, services, etc., that when the code that defines such software is executed by the processor 1510 and/or one or more other processors included within and/or associated with the processing system 1502, it causes the system to perform a function. In some aspects, a hardware service that performs a particular function may include the software component stored in a computer-readable medium in connection with the necessary hardware components, such as processor 1510 (e.g., and/or one or more other processors included within and/or associated with the processing system 1502), connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communication at a device, comprising: one or more memories; and one or more processors coupled to the one or more memories and configured to cause the device to: obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including at least one corresponding tone from the respective set of tones corresponding to each CB; determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and output, using the interleaved tone sequence, the plurality of tones on the aggregated bandwidth.

Aspect 2. The apparatus of Aspect 1, wherein: each block of tones of the first sequence of the blocks of tones comprises a respective subset of tones included in the plurality of tones; and a number of tones in the respective subset of tones is equal to a number of CBs of the set of CBs.

Aspect 3. The apparatus of any of Aspects 1 to 2, wherein: a plurality of tone index values is mapped to the respective set of tones corresponding to each CB of the set of CBs; and each block of tones of the first sequence of the blocks of tones corresponds to a particular tone index value of the plurality of tone index values.

Aspect 4. The apparatus of Aspect 3, wherein each block of tones of the first sequence of the blocks of tones comprises a respective subset of tones included in the plurality of tones, and wherein each tone of the respective subset of tones is mapped to the particular tone index value within the respective set of tones for a different CB of the set of CBs.

Aspect 5. The apparatus of any of Aspects 1 to 4, wherein one or more tones from each respective set of tones are mapped to one or more corresponding resource elements (REs) associated with each carrier of the plurality of carriers based at least in part on the interleaved tone sequence.

Aspect 6. The apparatus of any of Aspects 1 to 5, wherein: consecutive tones within the respective set of tones corresponding to each CB are mapped to different carriers of the plurality of carriers based on the interleaved tone sequence; and each pair of consecutive tones of a plurality of pairs of consecutive tones within the respective set of tones corresponding to each CB are separated in frequency by a threshold number of resource elements (REs).

Aspect 7. The apparatus of any of Aspects 1 to 6, wherein: consecutive tones within the respective set of tones corresponding to each CB are mapped to different carriers of the plurality of carriers based on the interleaved tone sequence.

Aspect 8. The apparatus of any of Aspects 1 to 7, wherein: each pair of consecutive tones of a plurality of pairs of consecutive tones within the respective set of tones corresponding to each CB are separated in frequency by a threshold number of resource elements (REs).

Aspect 9. The apparatus of any of Aspects 6 to 8, wherein the threshold number of REs is the same for each pair of consecutive tones of the plurality of pairs of consecutive tones.

Aspect 10. The apparatus of any of Aspects 1 to 9, wherein the interleaving configuration includes an indication of an interleaving size and an interleaving depth corresponding to the interleaved tone sequence.

Aspect 11. The apparatus of any of Aspects 1 to 10, wherein each block of tones of the first sequence of the blocks of tones includes a number of respective tones of the plurality of tones equal to a number of CBs of the set of CBs.

Aspect 12. The apparatus of any of Aspects 1 to 11, wherein the one or more processors are configured to cause the device to: transmit information indicative of the interleaving configuration, wherein the information is included in control information corresponding to at least one of a Multimedia Broadcast Multicast Service (MBMS) associated with the apparatus, or a Multicast-Broadcast Single Frequency Network (MBSFN) Area associated with the apparatus.

Aspect 13. The apparatus of any of Aspects 1 to 12, wherein the one or more processors are configured to cause the device to: transmit information indicative of the interleaving configuration, wherein the information is included in control information corresponding to a Multimedia Broadcast Multicast Service (MBMS) associated with the apparatus.

Aspect 14. The apparatus of any of Aspects 1 to 13, wherein the one or more processors are configured to cause the device to: transmit information indicative of the interleaving configuration, wherein the information is included in control information corresponding to a Multicast-Broadcast Single Frequency Network (MBSFN) Area associated with the apparatus.

Aspect 15. The apparatus of any of Aspects 1 to 14, wherein the one or more processors are configured to cause the device to: transmit a multicast control channel (MCCH) message including information indicative of the interleaving configuration.

Aspect 16. The apparatus of Aspect 15, wherein the information indicative of the interleaving configuration is included in a Multicast-Broadcast Single Frequency Network (MBSFN) Area information element (IE) of the MCCH message.

Aspect 17. The apparatus of any of Aspects 1 to 16, wherein the one or more processors are configured to cause the device to: transmit information indicative of the interleaving configuration, wherein the information is included in a Multicast-Broadcast Single Frequency Network (MBSFN) Area information element (IE).

Aspect 18. The apparatus of any of Aspects 1 to 17, wherein the one or more processors are configured to cause the device to: transmit a Multicast Channel (MCH) Scheduling Information (MSI) Media Access Control (MAC) Control Element (MAC-CE), wherein the MSI MAC-CE includes information indicative of the interleaving configuration.

Aspect 19. The apparatus of any of Aspects 1 to 18, wherein the one or more processors are configured to cause the device to: transmit first signaling including an indication to enable frequency interleaving of the plurality of tones of the set of CBs across the plurality of carriers; and transmit second signaling indicative of one or more parameters for the interleaving configuration, wherein the one or more parameters include one or more of an interleaving size or an interleaving depth.

Aspect 20. The apparatus of any of Aspects 1 to 19, wherein the one or more processors are configured to cause the device to: transmit first signaling including an indication to enable frequency interleaving of the plurality of tones of the set of CBs across the plurality of carriers.

Aspect 21. The apparatus of any of Aspects 1 to 20, wherein the one or more processors are configured to cause the device to: transmit second signaling indicative of one or more parameters for the interleaving configuration, wherein the one or more parameters include one or more of an interleaving size or an interleaving depth.

Aspect 22. The apparatus of any of Aspects 19 to 21, wherein, to transmit the second signaling, the one or more processors are configured to cause the device to: transmit a Multicast Channel (MCH) Scheduling Information (MSI) message, wherein the MSI message includes configured values for the interleaving size and the interleaving depth.

Aspect 23. The apparatus of any of Aspects 1 to 22, wherein the one or more processors are configured to cause the device to: transmit information indicative of the interleaving configuration, wherein the information comprises an index value corresponding to a particular configuration of one or more parameters to determine the interleaved tone sequence, and wherein the index value is included in a plurality of configured index values corresponding to a plurality of configurations of the one or more parameters.

Aspect 24. The apparatus of any of Aspects 1 to 23, wherein the one or more processors are configured to cause the device to: transmit information indicative of the interleaving configuration, wherein the information comprises an index value corresponding to a particular configuration of one or more parameters to determine the interleaved tone sequence,

Aspect 25. The apparatus of any of Aspects 1 to 24, wherein the index value is included in a plurality of configured index values corresponding to a plurality of configurations of the one or more parameters.

Aspect 26. The apparatus of any of Aspects 1 to 25, wherein the one or more processors are configured to cause the device to: transmit information indicative of the interleaving configuration, wherein the information is transmitted using at least one of: a group-common downlink control information (GC-DCI), or a group-common physical downlink control channel (GC-PDCCH) including cross-carrier scheduling information associated with the plurality of carriers and indicative of the information.

Aspect 27. The apparatus of any of Aspects 1 to 26, wherein the one or more processors are configured to cause the device to: transmit information indicative of the interleaving configuration, wherein the information is transmitted using a group-common downlink control information (GC-DCI)

Aspect 28. The apparatus of any of Aspects 1 to 27, wherein the one or more processors are configured to cause the device to: transmit information indicative of the interleaving configuration, wherein the information is transmitted using a group-common physical downlink control channel (GC-PDCCH) including cross-carrier scheduling information associated with the plurality of carriers and indicative of the information.

Aspect 29. The apparatus of any of Aspects 1 to 28, wherein: the one or more processors are configured to cause the device to transmit signaling indicative of block size information for the first sequence of blocks of tones, wherein the block size information corresponds to a number of tones included in each block of the first sequence of blocks; and the signaling includes radio resource control (RRC) signaling, media access control (MAC)-control element (MAC-CE) signaling, or downlink control information (DCI) signaling.

Aspect 30. The apparatus of any of Aspects 1 to 29, wherein: the one or more processors are configured to cause the device to transmit signaling indicative of block size information for the first sequence of blocks of tones, wherein the block size information corresponds to a number of tones included in each block of the first sequence of blocks.

Aspect 31. The apparatus of any of Aspects 1 to 30, wherein: the signaling includes radio resource control (RRC) signaling, media access control (MAC)-control element (MAC-CE) signaling, or downlink control information (DCI) signaling.

Aspect 32. The apparatus of any of Aspects 1 to 31, wherein, to determine the interleaved tone sequence, the one or more processors are configured to cause the device to: determine one or more prioritized blocks of tones of the first sequence of the blocks of tones, wherein the one or more prioritized blocks of tones include respective tones corresponding to prioritized CBs of the set of CBs; map the corresponding tones included in each of the one or more prioritized blocks of tones to respective carriers of the plurality of carriers; and map the corresponding tones included in a remaining set of blocks of tones of the first sequence of the blocks of tones to respective carriers of the plurality of carriers, wherein the remaining set of blocks of tones is mapped after the prioritized blocks of tones are mapped.

Aspect 33. The apparatus of any of Aspects 1 to 32, wherein, to determine the interleaved tone sequence, the one or more processors are configured to cause the device to: determine one or more prioritized blocks of tones of the first sequence of the blocks of tones, wherein the one or more prioritized blocks of tones include respective tones corresponding to prioritized CBs of the set of CBs.

Aspect 34. The apparatus of any of Aspects 1 to 33, wherein, to determine the interleaved tone sequence, the one or more processors are configured to cause the device to: map the corresponding tones included in each of the one or more prioritized blocks of tones to respective carriers of the plurality of carriers.

Aspect 35. The apparatus of any of Aspects 1 to 34, wherein, to determine the interleaved tone sequence, the one or more processors are configured to cause the device to: map the corresponding tones included in a remaining set of blocks of tones of the first sequence of the blocks of tones to respective carriers of the plurality of carriers, wherein the remaining set of blocks of tones is mapped after the prioritized blocks of tones are mapped.

Aspect 36. The apparatus of any of Aspects 1 to 35, wherein a number of resource elements (REs) corresponding to each carrier of the plurality of carriers is the same.

Aspect 37. The apparatus of Aspect 36, wherein the number of REs corresponding to each carrier of the plurality of carriers is a multiple of a number of CBs in the set of CBs.

Aspect 38. The apparatus of Aspect 37, wherein: to determine the interleaved tone sequence, the one or more processors are configured to cause the device to map each respective block of tones of the first sequence of the blocks of tones to a respective carrier determined from a set of available carriers; each respective block of tones is mapped using a mapping order corresponding to an order of each respective block of tones in the first sequence; and the set of available carriers comprises one or more carriers of the plurality of carriers with a respective quantity of available REs greater than or equal to a quantity of tones in each respective block of tones.

Aspect 39. The apparatus of any of Aspects 37 to 38, wherein: to determine the interleaved tone sequence, the one or more processors are configured to cause the device to map each respective block of tones of the first sequence of the blocks of tones to a respective carrier determined from a set of available carriers.

Aspect 40. The apparatus of any of Aspects 37 to 39, wherein: each respective block of tones is mapped using a mapping order corresponding to an order of each respective block of tones in the first sequence.

Aspect 41. The apparatus of any of Aspects 37 to 40, wherein: the set of available carriers comprises one or more carriers of the plurality of carriers with a respective quantity of available REs greater than or equal to a quantity of tones in each respective block of tones.

Aspect 42. The apparatus of any of Aspects 37 to 41, wherein the number of REs corresponding to each carrier of the plurality of carriers is equal to a multiple of a number of CBs in the set of CBs plus a remainder, wherein the remainder is less than the number of CBs.

Aspect 43. The apparatus of Aspect 42, wherein: to determine the interleaved tone sequence, the one or more processors are configured cause the device to perform rate matching for the number of REs corresponding to each carrier of the plurality of carriers; and the interleaved tone sequence is determined based on using a subset of REs corresponding to each carrier equal to the multiple of the number of CBs.

Aspect 44. The apparatus of any of Aspects 42 to 43, wherein: to determine the interleaved tone sequence, the one or more processors are configured cause the device to perform rate matching for the number of REs corresponding to each carrier of the plurality of carriers.

Aspect 45. The apparatus of any of Aspects 42 to 44, wherein: the interleaved tone sequence is determined based on using a subset of REs corresponding to each carrier equal to the multiple of the number of CBs.

Aspect 46. The apparatus of any of Aspects 43 to 45, wherein: each carrier of the plurality of carriers includes a first quantity of REs equal to the multiple of the number of CBs, and includes a second quantity of REs equal to the remainder; and the one or more processors are configured to cause the device to determine the interleaved tone sequence without using the second quantity of REs included in each carrier of the plurality of carriers.

Aspect 47. The apparatus of any of Aspects 1 to 46, wherein the plurality of carriers comprises a plurality of component carriers associated with carrier aggregation by the apparatus.

Aspect 48. The apparatus of Aspect 47, wherein at least a subset of component carriers of the plurality of component carriers are non-contiguous in frequency.

Aspect 49. The apparatus of any of Aspects 1 to 48, wherein the aggregated bandwidth is associated with carrier aggregation by the apparatus using at least one of a broadcast configuration or a multicast configuration.

Aspect 50. The apparatus of any of Aspects 1 to 49, wherein, to output the plurality of tones, the one or more processors are configured to cause the device to: perform allocation of the plurality of tones across respective resource elements (REs) for the plurality of carriers based on the interleaved tone sequence; and broadcast or multicast the plurality of tones according to the allocation.

Aspect 51. The apparatus of any of Aspects 1 to 50, wherein the first sequence is a first interleaved sequence for the plurality of tones and corresponds to a sub-block interleaver of the apparatus.

Aspect 52. The apparatus of any of Aspects 1 to 51, wherein, to obtain the plurality of tones, the one or more processors are configured to cause the device to obtain the plurality of tones arranged in the first sequence from a sub-block frequency interleaver.

Aspect 53. The apparatus of any of Aspects 1 to 52, wherein the plurality of tones are output as a downlink transmission corresponding to the aggregated bandwidth.

Aspect 54. The apparatus of any of Aspects 1 to 53, wherein the device is a network entity, and wherein the one or more processors are configured to cause the device to: transmit information indicative of the interleaving configuration associated with the aggregated bandwidth.

Aspect 55. The apparatus of Aspect 54, wherein: the one or more processors are configured to cause the device to transmit the information to one or more user equipments (UEs); and to output the plurality of tones, the one or more processors are configured to cause the device to transmit, to the one or more UEs, the plurality of tones on the aggregated bandwidth, wherein the plurality of tones are transmitted using the interleaved tone sequence.

Aspect 56. The apparatus of any of Aspects 1 to 55, wherein the plurality of tones are output as an uplink transmission corresponding to the aggregated bandwidth.

Aspect 57. The apparatus of any of Aspects 1 to 56, wherein the one or more processors are configured to cause the device to: obtain information indicative of the interleaving configuration associated with the aggregated bandwidth.

Aspect 58. The apparatus of Aspect 57, wherein: to obtain the information, the one or more processors are configured to cause the device to receive the information from a network entity; and to output the plurality of tones, the one or more processors are configured to cause the device to transmit, to the network entity, the plurality of tones using the interleaved tone sequence on the aggregated bandwidth.

Aspect 59. The apparatus of any of Aspects 1 to 58, wherein the device is a user equipment (UE).

Aspect 60. An apparatus for wireless communication at a user equipment (UE), comprising: one or more memories; and one or more processors coupled to the one or more memories and configured to cause the UE to: receive information indicative of an interleaving configuration associated with an aggregated bandwidth, wherein the aggregated bandwidth includes a plurality of carriers; receive a transmission corresponding to an interleaved tone sequence of a plurality of tones, wherein the transmission is received using the aggregated bandwidth; determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

Aspect 61. The apparatus of Aspect 60, wherein the one or more processors are configured to cause the UE to receive the information indicative of the interleaving configuration from a network entity associated with at least one of the transmission or the interleaved tone sequence.

Aspect 62. The apparatus of Aspect 61, wherein the one or more processors are configured to cause the UE to receive the transmission from the network entity.

Aspect 63. The apparatus of any of Aspects 60 to 62, wherein a number of tones in the subset of tones is equal to a number of the plurality of carriers.

Aspect 64. The apparatus of any of Aspects 60 to 63, wherein the interleaving configuration is indicative of an interleaving size and an interleaving depth corresponding to the interleaved tone sequence.

Aspect 65. The apparatus of any of Aspects 60 to 64, wherein each block of tones of the plurality of blocks of tones includes a number of respective tones of the plurality of tones equal to a number of CBs of the set of CBs.

Aspect 66. The apparatus of any of Aspects 60 to 65, wherein, to receive the information indicative of the interleaving configuration, the one or more processors are configured to cause the UE to: receive control information corresponding to at least one of a Multimedia Broadcast Multicast Service (MBMS) or a Multicast-Broadcast Single Frequency Network (MBSFN) Area.

Aspect 67. The apparatus of any of Aspects 60 to 66, wherein, to receive the information indicative of the interleaving configuration, the one or more processors are configured to cause the UE to: receive a multicast control channel (MCCH) message including the information.

Aspect 68. The apparatus of Aspect 67, wherein the information indicative of the interleaving configuration is included in a Multicast-Broadcast Single Frequency Network (MBSFN) Area information element (IE) of the MCCH message.

Aspect 69. The apparatus of any of Aspects 60 to 68, wherein, to receive the information indicative of the interleaving configuration, the one or more processors are configured to cause the UE to: receive a Multicast Channel (MCH) Scheduling Information (MSI) Media Access Control (MAC) Control Element (MAC-CE), wherein the MSI MAC-CE includes the information.

Aspect 70. The apparatus of any of Aspects 60 to 69, wherein the one or more processors are configured to cause the UE to: receive first signaling including an indication to enable frequency interleaving of the plurality of tones of the set of CBs across the plurality of carriers; and receive second signaling indicative of one or more parameters for the interleaving configuration, wherein the one or more parameters include one or more of an interleaving size or an interleaving depth.

Aspect 71. The apparatus of Aspect 70, wherein, to receive the second signaling, the one or more processors are configured to cause the UE to: receive a Multicast Channel (MCH) Scheduling Information (MSI) message, wherein the MSI message includes configured values for the interleaving size and the interleaving depth.

Aspect 72. The apparatus of any of Aspects 60 to 71, wherein the information indicative of the interleaving configuration includes an index value corresponding to a particular configuration of one or more parameters used to determine the interleaved tone sequence, and wherein the index value is included in a plurality of configured index values corresponding to a plurality of configurations of the one or more parameters.

Aspect 73. The apparatus of any of Aspects 60 to 72, wherein the information indicative of the interleaving configuration is included in at least one of: group-common downlink control information (GC-DCI) or a group-common physical downlink control channel (GC-PDCCH) including cross-carrier scheduling information associated with the plurality of carriers and indicative of the information.

Aspect 74. The apparatus of any of Aspects 60 to 73, wherein the one or more processors are configured to cause the UE to: receive signaling indicative of block size information associated with the interleaved tone sequence, wherein the block size information corresponds to a number of tones included in each block of tones of the plurality of blocks of tones; and determine the de-interleaved sequence using the block size information.

Aspect 75. The apparatus of Aspect 74, wherein the signaling indicative of block size information includes radio resource control (RRC) signaling, media access control (MAC)-control element (MAC-CE) signaling, or downlink control information (DCI) signaling.

Aspect 76. The apparatus of any of Aspects 60 to 75, wherein the transmission corresponding to an interleaved tone sequence is a broadcast or a multicast by a network entity, and wherein the one or more processors are configured to cause the UE to receive the information indicative of the interleaving configuration from the network entity.

Aspect 77. A method for wireless communication at a device, comprising: obtaining a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB; determining, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and outputting, using the interleaved tone sequence, the plurality of tones on the aggregated bandwidth.

Aspect 78. The method of Aspect 77, wherein: each block of tones of the first sequence of the blocks of tones comprises a respective subset of tones included in the plurality of tones; and a number of tones in the respective subset of tones is equal to a number of CBs of the set of CBs.

Aspect 79. The method of any of Aspects 77 to 78, wherein: a plurality of tone index values is mapped to the respective set of tones corresponding to each CB of the set of CBs; and each block of tones of the first sequence of the blocks of tones corresponds to a particular tone index value of the plurality of tone index values.

Aspect 80. The method of Aspect 79, wherein each block of tones of the first sequence of the blocks of tones comprises a respective subset of tones included in the plurality of tones, and wherein each tone of the respective subset of tones is mapped to the particular tone index value within the respective set of tones for a different CB of the set of CBs.

Aspect 81. The method of any of Aspects 77 to 80, wherein one or more tones from each respective set of tones are mapped to one or more corresponding resource elements (REs) associated with each carrier of the plurality of carriers based at least in part on the interleaved tone sequence.

Aspect 82. The method of any of Aspects 77 to 81, wherein: consecutive tones within the respective set of tones corresponding to each CB are mapped to different carriers of the plurality of carriers based on the interleaved tone sequence; and each pair of consecutive tones of a plurality of pairs of consecutive tones within the respective set of tones corresponding to each CB are separated in frequency by a threshold number of resource elements (REs).

Aspect 83. The method of any of Aspects 77 to 82, wherein: consecutive tones within the respective set of tones corresponding to each CB are mapped to different carriers of the plurality of carriers based on the interleaved tone sequence.

Aspect 84. The method of any of Aspects 77 to 83, wherein: each pair of consecutive tones of a plurality of pairs of consecutive tones within the respective set of tones corresponding to each CB are separated in frequency by a threshold number of resource elements (REs).

Aspect 85. The method of any of Aspects 82 to 84, wherein the threshold number of REs is the same for each pair of consecutive tones of the plurality of pairs of consecutive tones.

Aspect 86. The method of any of Aspects 77 to 85, wherein the interleaving configuration includes an indication of an interleaving size and an interleaving depth corresponding to the interleaved tone sequence.

Aspect 87. The method of any of Aspects 77 to 86, wherein each block of tones of the first sequence of the blocks of tones includes a number of respective tones of the plurality of tones equal to a number of CBs of the set of CBs.

Aspect 88. The method of any of Aspects 77 to 87, further comprising: transmitting information indicative of the interleaving configuration, wherein the information is included in control information corresponding to at least one of a Multimedia Broadcast Multicast Service (MBMS) associated with the apparatus, or a Multicast-Broadcast Single Frequency Network (MBSFN) Area associated with the apparatus.

Aspect 89. The method of any of Aspects 77 to 88, further comprising: transmitting information indicative of the interleaving configuration, wherein the information is included in control information corresponding to a Multimedia Broadcast Multicast Service (MBMS) associated with the apparatus.

Aspect 90. The method of any of Aspects 77 to 89, further comprising: transmitting information indicative of the interleaving configuration, wherein the information is included in control information corresponding to a Multicast-Broadcast Single Frequency Network (MBSFN) Area associated with the apparatus.

Aspect 91. The method of any of Aspects 77 to 90, further comprising: transmitting a multicast control channel (MCCH) message including information indicative of the interleaving configuration.

Aspect 92. The method of Aspect 91, wherein the information indicative of the interleaving configuration is included in a Multicast-Broadcast Single Frequency Network (MBSFN) Area information element (IE) of the MCCH message.

Aspect 93. The method of any of Aspects 77 to 92, further comprising: transmitting information indicative of the interleaving configuration, wherein the information is included in a Multicast-Broadcast Single Frequency Network (MBSFN) Area information element (IE).

Aspect 94. The method of any of Aspects 77 to 93, further comprising: transmitting a Multicast Channel (MCH) Scheduling Information (MSI) Media Access Control (MAC) Control Element (MAC-CE), wherein the MSI MAC-CE includes information indicative of the interleaving configuration.

Aspect 95. The method of any of Aspects 77 to 94, further comprising: transmitting first signaling including an indication to enable frequency interleaving of the plurality of tones of the set of CBs across the plurality of carriers; and transmitting second signaling indicative of one or more parameters for the interleaving configuration, wherein the one or more parameters include one or more of an interleaving size or an interleaving depth.

Aspect 96. The method of any of Aspects 77 to 95, further comprising: transmitting first signaling including an indication to enable frequency interleaving of the plurality of tones of the set of CBs across the plurality of carriers.

Aspect 97. The method of any of Aspects 77 to 96, further comprising: transmitting second signaling indicative of one or more parameters for the interleaving configuration, wherein the one or more parameters include one or more of an interleaving size or an interleaving depth.

Aspect 98. The method of any of Aspects 95 to 97, wherein transmitting the second signaling comprises: transmitting a Multicast Channel (MCH) Scheduling Information (MSI) message, wherein the MSI message includes configured values for the interleaving size and the interleaving depth.

Aspect 99. The method of any of Aspects 77 to 98, further comprising: transmitting information indicative of the interleaving configuration, wherein the information comprises an index value corresponding to a particular configuration of one or more parameters to determine the interleaved tone sequence, and wherein the index value is included in a plurality of configured index values corresponding to a plurality of configurations of the one or more parameters.

Aspect 100. The method of any of Aspects 77 to 99, further comprising: transmitting information indicative of the interleaving configuration, wherein the information comprises an index value corresponding to a particular configuration of one or more parameters to determine the interleaved tone sequence,
Aspect 101. The method of any of Aspects 77 to 100, wherein the index value is included in a plurality of configured index values corresponding to a plurality of configurations of the one or more parameters.

Aspect 102. The method of any of Aspects 77 to 101, further comprising: transmitting information indicative of the interleaving configuration, wherein the information is transmitted using at least one of: a group-common downlink control information (GC-DCI), or a group-common physical downlink control channel (GC-PDCCH) including cross-carrier scheduling information associated with the plurality of carriers and indicative of the information.

Aspect 103. The method of any of Aspects 77 to 102, further comprising: transmitting information indicative of the interleaving configuration, wherein the information is transmitted using a group-common downlink control information (GC-DCI)

Aspect 104. The method of any of Aspects 77 to 103, further comprising: transmitting information indicative of the interleaving configuration, wherein the information is transmitted using a group-common physical downlink control channel (GC-PDCCH) including cross-carrier scheduling information associated with the plurality of carriers and indicative of the information.

Aspect 105. The method of any of Aspects 77 to 104, further comprising transmitting signaling indicative of block size information for the first sequence of blocks of tones, wherein the block size information corresponds to a number of tones included in each block of the first sequence of blocks; and wherein the signaling includes radio resource control (RRC) signaling, media access control (MAC)-control element (MAC-CE) signaling, or downlink control information (DCI) signaling.

Aspect 106. The method of any of Aspects 77 to 105, further comprising transmitting signaling indicative of block size information for the first sequence of blocks of tones, wherein the block size information corresponds to a number of tones included in each block of the first sequence of blocks.

Aspect 107. The method of any of Aspects 77 to 106, wherein: the signaling includes radio resource control (RRC) signaling, media access control (MAC)-control element (MAC-CE) signaling, or downlink control information (DCI) signaling.

Aspect 107. The method of any of Aspects 77 to 106, wherein determining the interleaved tone sequence comprises: determining one or more prioritized blocks of tones of the first sequence of the blocks of tones, wherein the one or more prioritized blocks of tones include respective tones corresponding to prioritized CBs of the set of CBs; mapping the corresponding tones included in each of the one or more prioritized blocks of tones to respective carriers of the plurality of carriers; and mapping the corresponding tones included in a remaining set of blocks of tones of the first sequence of the blocks of tones to respective carriers of the plurality of carriers, wherein the remaining set of blocks of tones is mapped after the prioritized blocks of tones are mapped.

Aspect 108. The method of any of Aspects 77 to 107, wherein determining the interleaved tone sequence comprises: determining one or more prioritized blocks of tones of the first sequence of the blocks of tones, wherein the one or more prioritized blocks of tones include respective tones corresponding to prioritized CBs of the set of CBs.

Aspect 109. The method of any of Aspects 77 to 108, wherein determining the interleaved tone sequence comprises: mapping the corresponding tones included in each of the one or more prioritized blocks of tones to respective carriers of the plurality of carriers.

Aspect 110. The method of any of Aspects 77 to 109, wherein determining the interleaved tone sequence comprises: mapping the corresponding tones included in a remaining set of blocks of tones of the first sequence of the blocks of tones to respective carriers of the plurality of carriers, wherein the remaining set of blocks of tones is mapped after the prioritized blocks of tones are mapped.

Aspect 111. The method of any of Aspects 77 to 110, wherein a number of resource elements (REs) corresponding to each carrier of the plurality of carriers is the same.

Aspect 112. The method of any of Aspects 77 to 111, wherein the number of REs corresponding to each carrier of the plurality of carriers is a multiple of a number of CBs in the set of CBs.

Aspect 113. The method of Aspect 112, wherein: determining the interleaved tone sequence comprises mapping each respective block of tones of the first sequence of the blocks of tones to a respective carrier determined from a set of available carriers; each respective block of tones is mapped using a mapping order corresponding to an order of each respective block of tones in the first sequence; and the set of available carriers comprises one or more carriers of the plurality of carriers with a respective quantity of available REs greater than or equal to a quantity of tones in each respective block of tones.

Aspect 114. The method of any of Aspects 112 to 113, wherein: determining the interleaved tone sequence comprises mapping each respective block of tones of the first sequence of the blocks of tones to a respective carrier determined from a set of available carriers.

Aspect 115. The method of any of Aspects 112 to 114, wherein: each respective block of tones is mapped using a mapping order corresponding to an order of each respective block of tones in the first sequence.

Aspect 116. The method of any of Aspects 112 to 115, wherein: the set of available carriers comprises one or more carriers of the plurality of carriers with a respective quantity of available REs greater than or equal to a quantity of tones in each respective block of tones.

Aspect 117. The method of any of Aspects 112 to 116, wherein the number of REs corresponding to each carrier of the plurality of carriers is equal to a multiple of a number of CBs in the set of CBs plus a remainder, wherein the remainder is less than the number of CBs.

Aspect 118. The method of Aspect 117, wherein: determining the interleaved tone sequence comprises performing rate matching for the number of REs corresponding to each carrier of the plurality of carriers; and the interleaved tone sequence is determined based on using a subset of REs corresponding to each carrier equal to the multiple of the number of CBs.

Aspect 119. The method of any of Aspects 117 to 118, wherein: determining the interleaved tone sequence comprises performing rate matching for the number of REs corresponding to each carrier of the plurality of carriers.

Aspect 120. The method of any of Aspects 117 to 119, wherein: the interleaved tone sequence is determined based on using a subset of REs corresponding to each carrier equal to the multiple of the number of CBs.

Aspect 121. The method of Aspect 120, wherein: each carrier of the plurality of carriers includes a first quantity of REs equal to the multiple of the number of CBs, and includes a second quantity of REs equal to the remainder; and the one or more processors are configured to cause the device to determine the interleaved tone sequence without using the second quantity of REs included in each carrier of the plurality of carriers.

Aspect 122. The method of any of Aspects 77 to 121, wherein the plurality of carriers comprises a plurality of component carriers associated with carrier aggregation by the apparatus.

Aspect 123. The method of Aspect 122, wherein at least a subset of component carriers of the plurality of component carriers are non-contiguous in frequency.

Aspect 124. The method of any of Aspects 77 to 123, wherein the aggregated bandwidth is associated with carrier aggregation by the apparatus using at least one of a broadcast configuration or a multicast configuration.

Aspect 125. The method of any of Aspects 77 to 124, wherein outputting the plurality of tones comprises: performing allocation of the plurality of tones across respective resource elements (REs) for the plurality of carriers based on the interleaved tone sequence; and broadcasting or multicasting the plurality of tones according to the allocation.

Aspect 126. The method of any of Aspects 77 to 125, wherein the first sequence is a first interleaved sequence for the plurality of tones and corresponds to a sub-block interleaver of the apparatus.

Aspect 127. The method of any of Aspects 77 to 126, wherein obtaining the plurality of tones comprises obtaining the plurality of tones arranged in the first sequence from a sub-block frequency interleaver.

Aspect 128. The method of any of Aspects 77 to 127, wherein the plurality of tones are output as a downlink transmission corresponding to the aggregated bandwidth.

Aspect 129. The method of any of Aspects 77 to 128, wherein the device is a network entity configured to transmit information indicative of the interleaving configuration associated with the aggregated bandwidth.

Aspect 130. The method of Aspect 129, further comprising transmitting the information to one or more user equipments (UEs); and outputting the plurality of tones by transmitting, to the one or more UEs, the plurality of tones on the aggregated bandwidth, wherein the plurality of tones are transmitted using the interleaved tone sequence.

Aspect 131. The method of any of Aspects 77 to 130, wherein the plurality of tones are output as an uplink transmission corresponding to the aggregated bandwidth.

Aspect 132. The method of any of Aspects 77 to 131, further comprising: obtaining information indicative of the interleaving configuration associated with the aggregated bandwidth.

Aspect 133. A method for wireless communication at a user equipment (UE), comprising: receiving information indicative of an interleaving configuration associated with an aggregated bandwidth, wherein the aggregated bandwidth includes a plurality of carriers; receiving a transmission corresponding to an interleaved tone sequence of a plurality of tones, wherein the transmission is received using the aggregated bandwidth; determining, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

Aspect 134. The method of Aspect 133, further comprising receiving the information indicative of the interleaving configuration from a network entity associated with at least one of the transmission or the interleaved tone sequence.

Aspect 135. The method of Aspect 134, further comprising receiving the transmission from the network entity.

Aspect 136. The method of any of Aspects 133 to 135, wherein a number of tones in the subset of tones is equal to a number of the plurality of carriers.

Aspect 137. The method of any of Aspects 133 to 136, wherein the interleaving configuration is indicative of an interleaving size and an interleaving depth corresponding to the interleaved tone sequence.

Aspect 138. The method of any of Aspects 133 to 137, wherein each block of tones of the plurality of blocks of tones includes a number of respective tones of the plurality of tones equal to a number of CBs of the set of CBs.

Aspect 139. The method of any of Aspects 133 to 138, wherein receiving the information indicative of the interleaving configuration comprises: receiving control information corresponding to at least one of a Multimedia Broadcast Multicast Service (MBMS) or a Multicast-Broadcast Single Frequency Network (MBSFN) Area.

Aspect 140. The method of any of Aspects 133 to 139, wherein receiving the information indicative of the interleaving configuration comprises: receiving a multicast control channel (MCCH) message including the information.

Aspect 141. The method of Aspect 140, wherein the information indicative of the interleaving configuration is included in a Multicast-Broadcast Single Frequency Network (MBSFN) Area information element (IE) of the MCCH message.

Aspect 142. The method of any of Aspects 133 to 141, wherein receiving the information indicative of the interleaving configuration comprises: receiving a Multicast Channel (MCH) Scheduling Information (MSI) Media Access Control (MAC) Control Element (MAC-CE), wherein the MSI MAC-CE includes the information.

Aspect 143. The method of any of Aspects 133 to 142, further comprising: receiving first signaling including an indication to enable frequency interleaving of the plurality of tones of the set of CBs across the plurality of carriers; and receiving second signaling indicative of one or more parameters for the interleaving configuration, wherein the one or more parameters include one or more of an interleaving size or an interleaving depth.

Aspect 144. The method of Aspect 143, wherein receiving the second signaling comprises: receiving a Multicast Channel (MCH) Scheduling Information (MSI) message, wherein the MSI message includes configured values for the interleaving size and the interleaving depth.

Aspect 145. The method of any of Aspects 133 to 144, wherein the information indicative of the interleaving configuration includes an index value corresponding to a particular configuration of one or more parameters used to determine the interleaved tone sequence, and wherein the index value is included in a plurality of configured index values corresponding to a plurality of configurations of the one or more parameters.

Aspect 146. The method of any of Aspects 133 to 145, wherein the information indicative of the interleaving configuration is included in at least one of: group-common downlink control information (GC-DCI) or a group-common physical downlink control channel (GC-PDCCH) including cross-carrier scheduling information associated with the plurality of carriers and indicative of the information.

Aspect 147. The method of any of Aspects 133 to 146, further comprising: receiving signaling indicative of block size information associated with the interleaved tone sequence, wherein the block size information corresponds to a number of tones included in each block of tones of the plurality of blocks of tones; and determining the de-interleaved sequence using the block size information.

Aspect 148. The method of Aspect 147, wherein the signaling indicative of block size information includes radio resource control (RRC) signaling, media access control (MAC)-control element (MAC-CE) signaling, or downlink control information (DCI) signaling.

Aspect 149. The method of any of Aspects 133 to 148, wherein the transmission corresponding to an interleaved tone sequence is a broadcast or a multicast by a network entity, and wherein the one or more processors are configured to cause the UE to receive the information indicative of the interleaving configuration from the network entity.

Aspect 150. A non-transitory computer-readable storage medium comprising instructions stored thereon which, when executed by at least one processor, causes the at least one processor to perform operations according to any of Aspects 1 to 59.

Aspect 151. A non-transitory computer-readable storage medium comprising instructions stored thereon which, when executed by at least one processor, causes the at least one processor to perform operations according to any of Aspects 60 to 76.

Aspect 152. An apparatus for wireless communication comprising one or more means for performing operations according to any of Aspects 1 to 59.

Aspect 153. An apparatus for wireless communication comprising one or more means for performing operations according to any of Aspects 60 to 76.

Aspect 154. The apparatus of Aspect 1, wherein the one or more processors are configured, individually or collectively, to cause the device to: obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including a corresponding tone from the respective set of tones corresponding to each CB; determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and output, using the interleaved tone sequence, the plurality of tones on the aggregated bandwidth.

Aspect 155. The apparatus of Aspect 60, wherein the one or more processors are configured, individually or collectively, to cause the UE to: receive information indicative of an interleaving configuration associated with an aggregated bandwidth, wherein the aggregated bandwidth includes a plurality of carriers; receive a transmission corresponding to an interleaved tone sequence of a plurality of tones, wherein the transmission is received using the aggregated bandwidth; determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.

Aspect 156. An apparatus for wireless communication at a device, comprising: a processing system that includes processor circuitry and memory circuitry that stores code and is coupled with the processor circuitry, the processing system configured to cause the device to perform the method of one or more of Aspects 77-132.

Aspect 157. An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 133-149.

What is claimed is:

1. An apparatus for wireless communication at a device, comprising:
one or more memories; and
one or more processors coupled to the one or more memories and configured to cause the device to:
obtain a plurality of tones scheduled for an aggregated bandwidth including a plurality of carriers, the plurality of tones including a respective set of tones corresponding to each code block (CB) of a set of CBs, wherein the plurality of tones is arranged in a first sequence of blocks of tones, each block of tones of the first sequence of the blocks of tones including at least one corresponding tone from the respective set of tones corresponding to each CB;
determine, based on the first sequence of the blocks of tones and an interleaving configuration associated with the aggregated bandwidth, an interleaved tone sequence for the plurality of tones, wherein the corresponding tones included in each block of tones of the first sequence of the blocks of tones are mapped to a respective carrier of the plurality of carriers based at least in part on the interleaved tone sequence; and
output, using the interleaved tone sequence, the plurality of tones on the aggregated bandwidth.

2. The apparatus of claim 1, wherein:
each block of tones of the first sequence of the blocks of tones comprises a respective subset of tones included in the plurality of tones; and
a number of tones in the respective subset of tones is equal to a number of CBs of the set of CBs.

3. The apparatus of claim 1, wherein:
a plurality of tone index values is mapped to the respective set of tones corresponding to each CB of the set of CBs; and
each block of tones of the first sequence of the blocks of tones corresponds to a particular tone index value of the plurality of tone index values.

4. The apparatus of claim 3, wherein each block of tones of the first sequence of the blocks of tones comprises a respective subset of tones included in the plurality of tones, and wherein each tone of the respective subset of tones is mapped to the particular tone index value within the respective set of tones for a different CB of the set of CBs.

5. The apparatus of claim 1, wherein one or more tones from each respective set of tones are mapped to one or more corresponding resource elements (REs) associated with each carrier of the plurality of carriers based at least in part on the interleaved tone sequence.

6. The apparatus of claim 1, wherein:
consecutive tones within the respective set of tones corresponding to each CB are mapped to different carriers of the plurality of carriers based on the interleaved tone sequence; and
each pair of consecutive tones of a plurality of pairs of consecutive tones within the respective set of tones corresponding to each CB are separated in frequency by a threshold number of resource elements (REs).

7. The apparatus of claim 6, wherein the threshold number of REs is the same for each pair of consecutive tones of the plurality of pairs of consecutive tones.

8. The apparatus of claim 1, wherein the interleaving configuration includes an indication of an interleaving size and an interleaving depth corresponding to the interleaved tone sequence.

9. The apparatus of claim 1, wherein the one or more processors are configured to cause the device to:
transmit information indicative of the interleaving configuration, wherein the information is included in control information corresponding to at least one of a Multimedia Broadcast Multicast Service (MBMS) associated with the apparatus, or a Multicast-Broadcast Single Frequency Network (MBSFN) Area associated with the apparatus.

10. The apparatus of claim 1, wherein the one or more processors are configured to cause the device to:
transmit a multicast control channel (MCCH) message including information indicative of the interleaving configuration.

11. The apparatus of claim 1, wherein:
the one or more processors are configured to cause the device to transmit signaling indicative of block size information for the first sequence of blocks of tones, wherein the block size information corresponds to a number of tones included in each block of the first sequence of blocks; and
the signaling includes radio resource control (RRC) signaling, media access control (MAC)-control element (MAC-CE) signaling, or downlink control information (DCI) signaling.

12. The apparatus of claim 1, wherein, to determine the interleaved tone sequence, the one or more processors are configured to cause the device to:
determine one or more prioritized blocks of tones of the first sequence of the blocks of tones, wherein the one or more prioritized blocks of tones include respective tones corresponding to prioritized CBs of the set of CBs;
map the corresponding tones included in each of the one or more prioritized blocks of tones to respective carriers of the plurality of carriers; and
map the corresponding tones included in a remaining set of blocks of tones of the first sequence of the blocks of tones to respective carriers of the plurality of carriers, wherein the remaining set of blocks of tones is mapped after the prioritized blocks of tones are mapped.

13. The apparatus of claim 1, wherein:
to determine the interleaved tone sequence, the one or more processors are configured to cause the device to map each respective block of tones of the first sequence of the blocks of tones to a respective carrier determined from a set of available carriers;
each respective block of tones is mapped using a mapping order corresponding to an order of each respective block of tones in the first sequence; and
the set of available carriers comprises one or more carriers of the plurality of carriers with a respective quantity of available REs greater than or equal to a quantity of tones in each respective block of tones.

14. The apparatus of claim 1, wherein:
to determine the interleaved tone sequence, the one or more processors are configured cause the device to perform rate matching for a number of REs corresponding to each carrier of the plurality of carriers; and
the interleaved tone sequence is determined based on using a subset of REs corresponding to each carrier equal to a multiple of a number of CBs in the set of CBs.

15. The apparatus of claim 1, wherein the plurality of carriers comprises a plurality of component carriers associated with carrier aggregation by the apparatus.

16. The apparatus of claim 1, wherein the aggregated bandwidth is associated with carrier aggregation by the apparatus using at least one of a broadcast configuration or a multicast configuration.

17. The apparatus of claim 1, wherein the device is a network entity, and wherein the one or more processors are configured to cause the device to:
transmit information indicative of the interleaving configuration associated with the aggregated bandwidth.

18. The apparatus of claim 1, wherein the one or more processors are configured to cause the device to:
obtain information indicative of the interleaving configuration associated with the aggregated bandwidth, wherein to obtain the information, the one or more processors are configured to cause the device to receive the information from a network entity; and
wherein, to output the plurality of tones, the one or more processors are configured to cause the device to transmit, to the network entity, the plurality of tones using the interleaved tone sequence on the aggregated bandwidth.

19. The apparatus of claim 1, wherein the device is a user equipment (UE).

20. An apparatus for wireless communication at a user equipment (UE), comprising:
one or more memories; and
one or more processors coupled to the one or more memories and configured to cause the UE to:
receive information indicative of an interleaving configuration associated with an aggregated bandwidth, wherein the aggregated bandwidth includes a plurality of carriers;
receive a transmission corresponding to an interleaved tone sequence of a plurality of tones, wherein the transmission is received using the aggregated bandwidth; and
determine, based on the interleaving configuration and the interleaved tone sequence, a de-interleaved sequence including a plurality of blocks of tones from the plurality of tones, wherein each block of tones of the plurality of blocks of tones includes at least one corresponding tone from a subset of tones of the plurality of tones, and wherein each subset of tones corresponds to a respective code block (CB) of a set of CBs associated with the transmission.
